(19) United States
(12) Patent Application Publication
(10) Pub. No.: US 2026/0252292 A1
(43) Pub. Date: Aug. 27, 2026

(54) FIRST IMAGE FORMING APPARATUS, SECOND IMAGE FORMING APPARATUS, AND PROCESSING METHOD

(71) Applicant: SEIKO EPSON CORPORATION, Tokyo (JP)

(72) Inventors: Akihiko SATOMI, Shiojiri (JP); Yoshinori MATSUMURA, Matsumoto (JP); Hideharu ONISHI, Shiojiri (JP)

(21) Appl. No.: 19/549,067

(22) Filed: Feb. 25, 2026

(30) Foreign Application Priority Data
Feb. 27, 2025 (JP) 2025-029864

(51) Int. Cl. G06F 3/12

(52) U.S. Cl. CPC G06F 3/1261; G06F 3/1204; G06F 3/1222; G06F 3/1236; G06F 3/1238; G06F 3/1291

(57) ABSTRACT

A first image forming apparatus includes a print data acquisition section, a change section, and a print data transmission section. The print data acquisition section acquires print data from a terminal device. The change section performs change processing of a first order in the print data. The print data transmission section transmits, to a second image forming apparatus, the print data subjected to the change processing of the first order.

The present application is based on, and claims priority from JP Application Serial Number 2025-029864, filed Feb. 27, 2025, the disclosure of which is hereby incorporated by reference herein in its entirety.

### BACKGROUND

### 1. Technical Field

The present disclosure relates to a first image forming apparatus, a second image forming apparatus, and a processing method.

### 2. Related Art

JP-A-2018-190146 discloses a print system. In the system according to JP-A-2018-190146, a print instruction device transmits data related to a print target document to a document storage device. A user selects, from among a plurality of image forming apparatuses, a print output device for which a print output is desired to be performed. Print data is acquired from the document storage device through a user authentication operation using an operation input section or the like of the print output device to perform the print output by the print output device.

In the technique described in JP-A-2018-190146, a desired print result may not be obtained when the print output device acquires the print data from the document storage device and performs the printing. For this reason, convenience may be reduced.

### SUMMARY

According to an aspect of the present disclosure, there is provided a first image forming apparatus including a print data acquisition section that acquires print data from a terminal device, a change section that performs change processing of a first order, which is an order in which the first image forming apparatus outputs the print data, in the print data, and a print data transmission section that transmits, to a second image forming apparatus, the print data subjected to the change processing of the first order.

According to another aspect of the present disclosure, there is provided a second image forming apparatus including an authentication section that executes authentication of a user, a print data acquisition section that acquires, when the authentication is successful, print data from a first image forming apparatus that acquires the print data from a terminal device or from the terminal device that transmits the print data to the first image forming apparatus, and a printing section that performs printing of the acquired print data, in which a first order, which is an order in which the first image forming apparatus outputs the print data, in the print data acquired by the print data acquisition section is subjected to change processing based on an order in which the print data is output by the second image forming apparatus.

According to still another aspect of the present disclosure, there is provided a processing method executed by a first image forming apparatus, the processing method including acquiring print data from a terminal device, performing change processing of a first order, which is an order in which the first image forming apparatus outputs the print data, in the print data, and transmitting, to a second image forming apparatus, the print data subjected to the change processing of the first order.

### BRIEF DESCRIPTION OF THE DRAWINGS

FIG. 1 is a diagram showing a processing system according to Embodiment 1.

FIG. 2 is a diagram for describing an outline of processing performed in the processing system according to Embodiment 1.

FIG. 3 is a diagram illustrating print original document data and print data according to Embodiment 1.

FIG. 4 is a diagram showing a configuration of a terminal device according to Embodiment 1.

FIG. 5 is a diagram showing a configuration of a first image forming apparatus according to Embodiment 1.

FIG. 6 is a diagram showing a configuration of a second image forming apparatus according to Embodiment 1.

FIG. 7 is a diagram showing processing executed by the processing system according to Embodiment 1.

FIG. 8 is a diagram showing processing executed by the processing system according to Embodiment 1.

FIG. 9 is a diagram for describing differences between a comparative example and Embodiment 1.

FIG. 10 is a diagram for describing differences between the comparative example and Embodiment 1.

FIG. 11 is a diagram showing a configuration of a terminal device according to Embodiment 2.

FIG. 12 is a diagram showing a configuration of the second image forming apparatus according to Embodiment 2.

FIG. 13 is a diagram showing processing executed by a processing system according to Embodiment 2.

FIG. 14 is a diagram showing a configuration of the first image forming apparatus according to Embodiment 3.

FIG. 15 is a diagram illustrating a model table according to Embodiment 3.

FIG. 16 is a diagram showing processing executed by a processing system according to Embodiment 3.

FIG. 17 is a diagram showing a configuration of the first image forming apparatus according to a first modification example of Embodiment 3.

FIG. 18 is a diagram illustrating a submachine table according to the first modification example of Embodiment 3.

FIG. 19 is a diagram showing a configuration of the first image forming apparatus according to a second modification example of Embodiment 3.

FIG. 20 is a diagram illustrating a change history according to the second modification example of Embodiment 3.

### DESCRIPTION OF EMBODIMENTS

### Embodiment 1

Hereinafter, embodiments will be described with reference to drawings. For clarification of the description, the following description and drawings are omitted and simplified as appropriate. Further, in each drawing, the same reference numerals are assigned to the same elements, and redundant description thereof will be omitted as necessary.

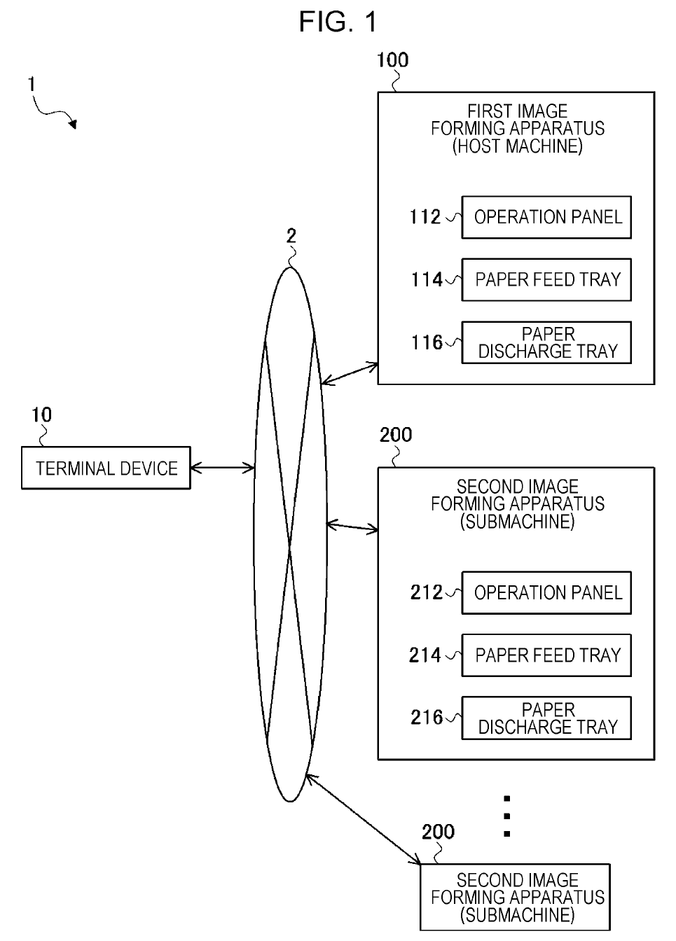

FIG. 1 is a diagram showing a processing system 1 according to Embodiment 1. The processing system 1 includes one or more terminal devices 10, a first image forming apparatus 100, and one or more second image forming apparatuses 200. The terminal device 10, the first image forming apparatus 100, and the second image forming apparatus 200 are communicably coupled to each other, via a wired or wireless network 2. The network 2 may be, for example, a local area network (LAN) such as a wired LAN or a wireless LAN, or the Internet.

The terminal device 10 has a function as a computer including a processor and a memory. The terminal device 10 operates by an OS, which is a basic software. The terminal device 10 is a device used by a user, such as a personal computer (PC), a smartphone, a tablet terminal, or a smart device. The terminal device 10 functions as a client PC. Details of the terminal device 10 will be described below.

The first image forming apparatus 100 is an image forming apparatus such as a printer. Further, the first image forming apparatus 100 may be, for example, a multifunction peripheral (MFP). The first image forming apparatus 100 performs image forming processing, that is, printing processing of forming an image on a print medium such as paper. The first image forming apparatus 100 functions, in the processing system 1, as a host machine. As shown in FIG. 1, the first image forming apparatus 100 includes at least an operation panel 112, a paper feed tray 114, and a paper discharge tray 116. The operation panel 112 is, for example, a touch panel in which a display device and an input device are integrated. The paper feed tray 114 stores the paper, which is the print medium, for example, for each paper size. The paper on which the image is formed is discharged to the paper discharge tray 116. Other components of the first image forming apparatus 100 will be described below.

The second image forming apparatus 200 is an image forming apparatus such as a printer. Further, the second image forming apparatus 200 may be, for example, a multifunction peripheral (MFP). The second image forming apparatus 200 performs image forming processing, that is, printing processing of forming an image on a print medium such as paper. The second image forming apparatus 200 functions, in the processing system 1, as a submachine. As shown in FIG. 1, the second image forming apparatus 200 includes at least an operation panel 212, a paper feed tray 214, and a paper discharge tray 216. The operation panel 212 is, for example, a touch panel in which a display device and an input device are integrated. The paper feed tray 214 stores the paper, which is the print medium, for example, for each paper size. The paper on which the image is formed is discharged to the paper discharge tray 216. Other components of the second image forming apparatus 200 will be described below.

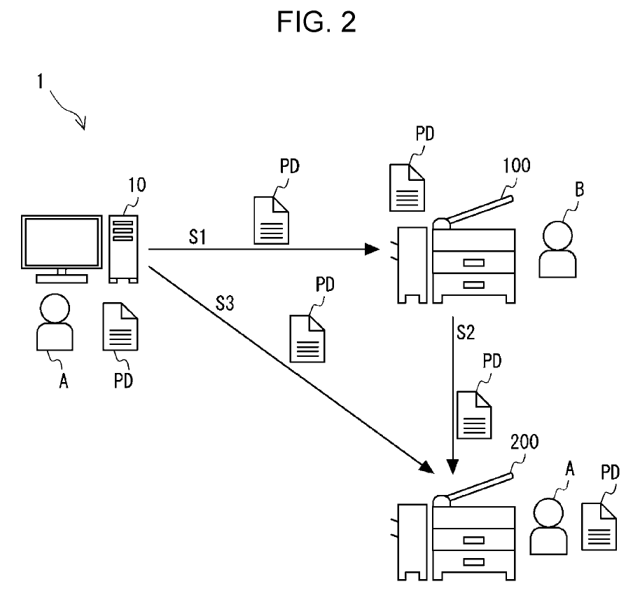

FIG. 2 is a diagram for describing an outline of processing performed in the processing system 1 according to Embodiment 1. The terminal device 10 generates print original document data by an operation of a user A. As indicated by an arrow S1, the terminal device 10 transmits, to the first image forming apparatus 100, print data PD corresponding to the print original document data by the operation of the user A. The print original document data and the print data PD indicate an image that the user A desires to be printed on the print medium. Further, the print data PD transmitted from the terminal device 10 to the first image forming apparatus 100 is generated to correspond to the printing processing in the first image forming apparatus 100. The print data PD will be described below. The first image forming apparatus 100 accumulates the print data PD received from the terminal device 10. The terminal device 10 may accumulate the print data PD transmitted to the first image forming apparatus 100 using, for example, a spooler.

When the first image forming apparatus 100 is used by a user B, the first image forming apparatus 100 cannot immediately print the print data PD. Thus, the user A performs processing such that the print data PD is printed by the second image forming apparatus 200. Specifically, the user A performs an operation to authenticate the user A on the second image forming apparatus 200. Accordingly, the second image forming apparatus 200 performs authentication processing for the user A. When the authentication of the user A is successful, the second image forming apparatus 200 requests the print data PD related to the user A from the first image forming apparatus 100. In this case, the first image forming apparatus 100 transmits a print job list, which is a list of print jobs related to the user A, to the second image forming apparatus 200. Accordingly, the operation panel 212 of the second image forming apparatus 200 displays the print job list related to the user A.

When the user A operates the operation panel 212 on which the print job list is displayed to select the print job related to the print data PD, the second image forming apparatus 200 transmits a selection result to the first image forming apparatus 100. As indicated by an arrow S2, the first image forming apparatus 100 transmits, to the second image forming apparatus 200, the print data PD corresponding to the print job indicated by the selection result. The second image forming apparatus 200 performs the printing processing on the acquired print data PD. Accordingly, the print medium on which the image of the print data PD is formed is discharged to the paper discharge tray 216.

When the print data PD is accumulated in the terminal device 10, the terminal device 10 may transmit the print data PD to the second image forming apparatus 200. Specifically, when the user A operates the operation panel 212 on which the print job list is displayed to select the print job related to the print data PD, the second image forming apparatus 200 may transmit the selection result to the terminal device 10. As indicated by an arrow S3, the terminal device 10 transmits, to the second image forming apparatus 200, the print data PD corresponding to the print job indicated by the selection result. The second image forming apparatus 200 performs the printing processing on the acquired print data PD. Accordingly, the print medium on which the image of the print data PD is formed is discharged to the paper discharge tray 216. In the print data PD, images of pages are arranged in an order in which the print data PD is printed by an image forming apparatus printing the print data PD. Hereinafter, details will be described.

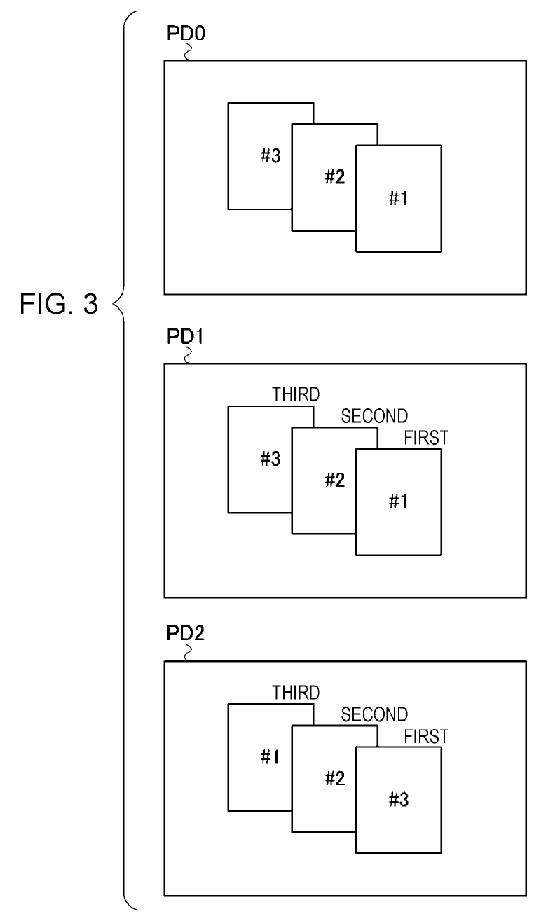

FIG. 3 is a diagram illustrating the print original document data and the print data according to Embodiment 1. Print original document data PD0 is generated by an application such as a document editing software or an image editing software. The print original document data may be, for example, a portable document format (PDF) data. The print original document data may include images of a plurality of pages. For example, when the print original document data PD0 is data of three pages, that is, data to be printed over three print media, the print original document data PD0 includes, as illustrated in FIG. 3, an image #1 of a first page, an image #2 of a second page, and an image #3 of a third page.

Based on the print original document data PD0, print data PD1 and print data PD2 are generated. The print data PD1 and the print data PD2 are generated according to a function of the image forming apparatus that prints the image of the print original document data PD0. For example, the print data PD1 and the print data PD2 are generated by a printer driver corresponding to the image forming apparatus that prints the image of the print original document data PD0.

Specifically, when the user operates the terminal device 10 to print the image of the print original document data PD0 by the image forming apparatus, which is a face-down machine, the terminal device 10 generates the print data PD1 by using the print original document data PD0. On the other hand, when the user operates the terminal device 10 to print the image of the print original document data PD0 by the image forming apparatus, which is a face-up machine, the terminal device 10 generates the print data PD2 by using the print original document data PD0. As will be described below, a print order, that is, an output order of a plurality of pages of the print original document data PD0 is different between the print data PD1 and the print data PD2. The output order is an order in which the image forming apparatus outputs the print data. More specifically, the output order is an order in which the image forming apparatus performs a print output of the pages of the print data. As will be described below, the output order of the print data is determined for each image forming apparatus. The output order of the image forming apparatus that outputs the print data differs depending on whether the image forming apparatus is the face-down machine or the face-up machine.

The face-down machine is an image forming apparatus in which a print medium is discharged to a paper discharge tray such that a printed surface after printing faces downward. That is, the face-down machine has a face-down paper discharge function of discharging the print medium to the paper discharge tray such that the printed surface after printing faces downward. The printed surface is a surface on which an image is formed at the print medium. In the face-down machine, a printed surface of a first printed page is a bottom surface of a bundle of the discharged print media. Thus, the face-down machine executes forward order printing in which a print target is printed in order from a first page to a last page. When the print original document data PD0 is printed in the face-down machine, first, the face-down machine forms an image #1 on a first print medium #1 and discharges the print medium #1 to the paper discharge tray. Next, the face-down machine forms an image #2 on a second print medium #2 and discharges the print medium #2 to the paper discharge tray. The face-down machine forms an image #3 on a third print medium #3 and discharges the print medium #3 to the paper discharge tray. Accordingly, a plurality of print media having lower surfaces on which images are formed in the order of the pages of the print original document data PD0 are loaded on the paper discharge tray.

Therefore, the print data PD1 corresponding to the face-down machine is generated such that the image #1 of the print original document data PD0 is output first, the image #2 is output second, and the image #3 is output third. Therefore, in the print data PD1, the images of the plurality of pages of the print original document data PD0 are generated in an arranged manner in an order of the image #1, the image #2, and the image #3. In other words, in the print data PD1, the plurality of pages in the print original document data PD0 are arranged in a forward order. Further, in other words, the output order of the print data PD1 is the forward order. When the pages of the print data PD1 are output, the face-down machine outputs the print data PD1 in the forward order, that is, in an order of the image #1, the image #2, and the image #3. That is, the output order of the print data in the face-down machine is the forward order.

On the other hand, the face-up machine is an image forming apparatus in which a print medium is discharged to a paper discharge tray such that a printed surface after printing faces upward. That is, the face-up machine has a face-up paper discharge function of discharging the print medium to the paper discharge tray such that the printed surface after printing faces upward. In the face-up machine, a printed surface of a last printed page is a top surface of a bundle of the discharged print media. Thus, the face-up machine executes reverse order printing in which a print target is printed in order from a last page to a first page since printed surfaces in the bundle of the discharged print media are in a state of being arranged in an original page order in a print original document. When the print original document data PD0 is printed in the face-up machine, first, the face-up machine forms the image #3 on the first print medium #1 and discharges the print medium #1 to the paper discharge tray. Next, the face-up machine forms the image #2 on the second print medium #2 and discharges the print medium #2 to the paper discharge tray. The face-up machine forms the image #1 on the third print medium #3 and discharges the print medium #3 to the paper discharge tray. Accordingly, a plurality of print media having upper surfaces on which images are formed in the order of the pages of the print original document data PD0 are loaded on the paper discharge tray.

Therefore, the print data PD2 corresponding to the face-up machine is generated such that the image #3 of the print original document data PD0 is output first, the image #2 is output second, and the image #1 is output third. Therefore, in the print data PD2, the images of the plurality of pages of the print original document data PD0 are generated in an arranged manner in an order of the image #3, the image #2, and the image #1. In other words, in the print data PD2, the plurality of pages in the print original document data PD0 are arranged in a reverse order. Further, in other words, the output order of the print data PD2 is the reverse order. When the pages of the print data PD2 are output, the face-up machine outputs the print data PD2 in the reverse order, that is, in an order of the image #3, the image #2, and the image #1. That is, the output order of the print data in the face-up machine is the reverse order.

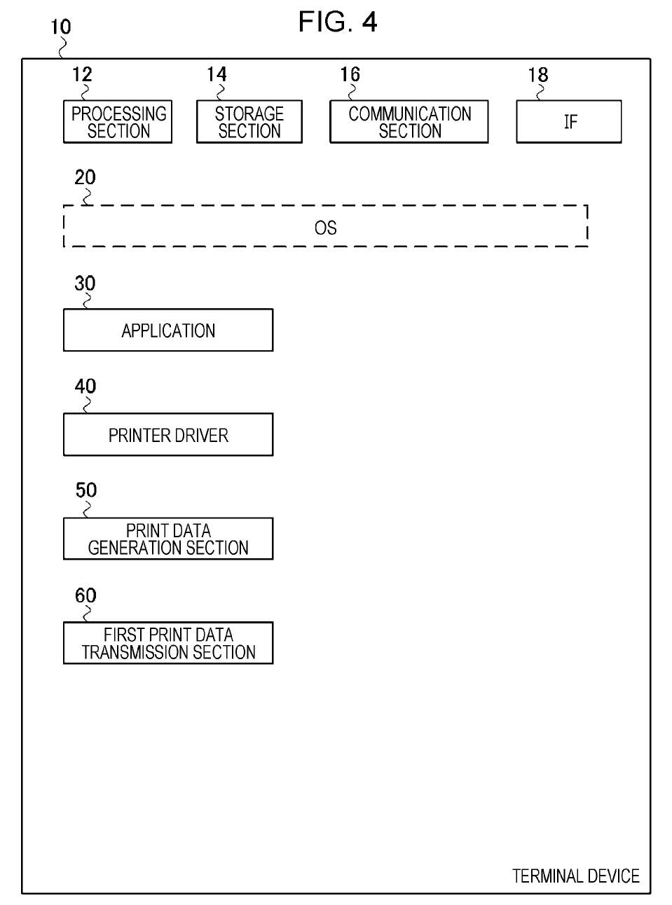

FIG. 4 is a diagram showing a configuration of the terminal device 10 according to Embodiment 1. The terminal device 10 includes a processing section 12, a storage section 14, a communication section 16, and an interface section 18, as a main hardware configuration. The processing section 12, the storage section 14, the communication section 16, and the interface section 18 may be coupled to each other, via a data bus or the like.

The processing section 12 is a processor such as a central processing unit (CPU). The processing section 12 may have a plurality of processors. The processing section 12 has a function as a calculation device that performs control processing, calculation processing, and the like. The processing section 12 controls the storage section 14, the communication section 16, and the interface section 18.

The storage section 14 is a storage device such as a memory or a hard disk. The storage section 14 is, for example, a read only memory (ROM) or a random access memory (RAM). The storage section 14 has a function of storing a control program, a calculation program, and the like, which are executed by the processing section 12. Further, the storage section 14 has a function of temporarily storing processing data and the like. The storage section 14 may include a database.

The communication section 16 performs processing necessary for the terminal device 10 to perform communication with another device, via the network 2. The communication section 16 may include a communication port, a router, a firewall, and the like. The communication section 16 performs processing for the terminal device 10 to perform communication with the first image forming apparatus 100 and the second image forming apparatus 200. The communication section 16 may perform processing for the terminal device 10 to perform communication with the first image forming apparatus 100 and the second image forming apparatus 200, via a LAN such as a wireless LAN. Further, the communication section 16 may perform processing for the terminal device 10 to perform communication with the first image forming apparatus 100 and the second image forming apparatus 200, via the Internet.

The interface section 18 is, for example, a user interface. The interface section 18 receives an operation to input data by the user of the terminal device 10, and outputs information to the user. The interface section 18 has a display portion and an operation portion. The display portion is a display device, such as a display, that displays an image. The display portion is an output device that outputs information. The operation portion is an input device, such as a keyboard or a mouse, for inputting or selecting information. The operation portion is an input device that inputs information. The interface section 18 may be configured such that an input device and an output device are integrated, such as a touch screen or a touch panel. In this case, the display portion and the operation portion may be physically integrated. Further, the interface section 18 may have a speaker and a microphone.

Further, the terminal device 10 according to Embodiment 1 includes an operating system (OS) 20, an application 30, a printer driver 40, a print data generation section 50, and a first print data transmission section 60, as components. The OS 20 is basic software. Further, each component other than the OS 20 operates using a function of the OS 20.

Each component described above can be realized by, for example, execution of a program under the control of the processing section 12. More specifically, each component can be realized by the processing section 12 executing a program stored in the storage section 14. Further, a necessary program may be recorded on any non-volatile recording medium and installed as necessary to realize each component. This is the same in other embodiments.

Further, each component may be realized by any combination of hardware, firmware, and software, without being limited to being realized by software according to a program. Further, each component may be realized by using an integrated circuit, which is programmable by the user, such as a field-programmable gate array (FPGA) or a microcomputer. In this case, a program configured to include each component described above may be realized by using the integrated circuit. This is the same in other embodiments.

The application 30 is application software that can perform processing accompanied by printing. The application 30 may be, for example, the document editing software, spreadsheet software, the image editing software, or photo display software. The application 30 generates the print original document data.

The printer driver 40 is installed in the terminal device 10 by an operation of an installer. The printer driver 40 is software for controlling the image forming apparatus such as the first image forming apparatus 100 and the second image forming apparatus 200 to operate the image forming apparatus. The printer driver 40 generates the print job corresponding to the print original document data generated by the application 30. The printer driver 40 is provided for at least the first image forming apparatus 100. When the user performs an operation of causing the first image forming apparatus 100 to perform the printing processing of the print original document data, the printer driver 40 of the first image forming apparatus 100 generates the print job corresponding to the first image forming apparatus 100 by using the print original document data. The printer driver 40 may be provided for the second image forming apparatus 200. In this case, when the user performs an operation of causing the second image forming apparatus 200 to perform the printing processing of the print original document data, the printer driver 40 of the second image forming apparatus 200 generates the print job corresponding to the second image forming apparatus 200 by using the print original document data.

The print data generation section 50 generates the print data that is a print target in the first image forming apparatus 100, the print data being transmitted to the host machine, that is, the first image forming apparatus 100. The print data generation section 50 may be realized by the printer driver 40. The print data generation section 50 acquires the print original document data generated by the application 30. The print data generation section 50 generates the print data used in the first image forming apparatus 100 by using the print original document data.

The print data generation section 50 generates the print data in accordance with the function of the first image forming apparatus 100. In other words, the print data generation section 50 generates the print data in accordance with a first order, which is an order in which the first image forming apparatus 100 outputs the print data (output order). When the first image forming apparatus 100 is the face-down machine, the first order of the first image forming apparatus 100 is the forward order. On the other hand, when the first image forming apparatus 100 is the face-up machine, the first order of the first image forming apparatus 100 is the reverse order.

Specifically, when the first image forming apparatus 100 is the face-down machine, that is, when the first image forming apparatus 100 has the face-down paper discharge function, the print data generation section 50 generates the print data in the forward order for the print original document data. In other words, when the first image forming apparatus 100 is the face-down machine, the print data generation section 50 generates the print data in which the first order is the forward order. When the first image forming apparatus 100 is the face-down machine and the application 30 generates the print original document data PD0 illustrated in FIG. 3, the print data generation section 50 generates the print data PD1 illustrated in FIG. 3.

On the other hand, when the first image forming apparatus 100 is the face-up machine, that is, when the first image forming apparatus 100 has the face-up paper discharge function, the print data generation section 50 generates the print data in the reverse order for the print original document data. In other words, when the first image forming apparatus 100 is the face-up machine, the print data generation section 50 generates the print data in which the first order is the reverse order. When the first image forming apparatus 100 is the face-up machine and the application 30 generates the print original document data PD0 illustrated in FIG. 3, the print data generation section 50 generates the print data PD2 illustrated in FIG. 3.

The first print data transmission section 60 performs processing of transmitting, to the first image forming apparatus 100, the print data generated by the print data generation section 50. The first print data transmission section 60 may control the communication section 16 to transmit the print data to the first image forming apparatus 100. The first print data transmission section 60 may transmit the print job including the print data to the first image forming apparatus 100, as a print command for the first image forming apparatus 100. The print job (print command) may include the print data, print settings, user identification information which is identification information of the user of the terminal device 10, and a transmission point in time of the print job (print data). The user identification information may be identification information of the terminal device 10.

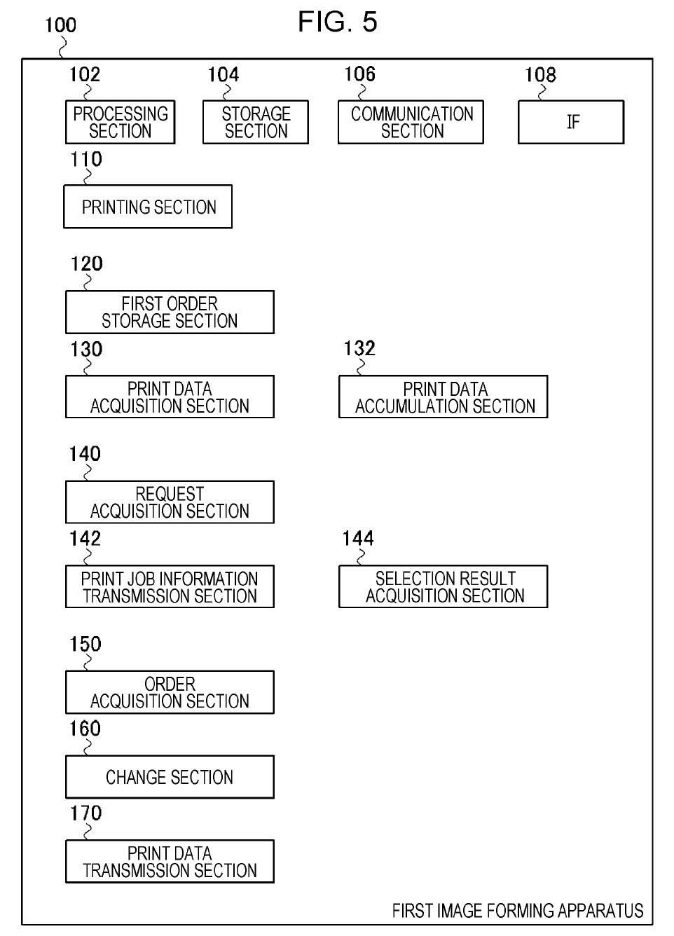

FIG. 5 is a diagram showing a configuration of the first image forming apparatus 100 according to Embodiment 1. The first image forming apparatus 100 includes a processing section 102, a storage section 104, a communication section 106, an interface section 108, and a printing section 110, as a main hardware configuration. The processing section 102, the storage section 104, the communication section 106, the interface section 108, and the printing section 110 may be coupled to each other, via a data bus or the like.

The processing section 102 is a processor such as a CPU. The processing section 102 may have a plurality of processors. The processing section 102 has a function as a calculation device that performs control processing, calculation processing, and the like. The processing section 102 controls the storage section 104, the communication section 106, the interface section 108, and the printing section 110.

The storage section 104 is a storage device such as a memory or a hard disk. The storage section 104 is, for example, a ROM or a RAM. The storage section 104 has a function of storing a control program, a calculation program, and the like, which are executed by the processing section 102. Further, the storage section 104 has a function of temporarily storing processing data and the like. The storage section 104 may include a database.

The communication section 106 performs processing necessary for the first image forming apparatus 100 to perform communication with another device, via the network 2. The communication section 106 may include a communication port, a router, a firewall, and the like. The communication section 106 performs processing for the first image forming apparatus 100 to perform communication with the terminal device 10 and the second image forming apparatus 200. The communication section 106 may perform processing for the first image forming apparatus 100 to perform communication with the terminal device 10 and the second image forming apparatus 200, via a LAN such as a wireless LAN. Further, the communication section 106 may perform processing for the first image forming apparatus 100 to perform communication with the terminal device 10 and the second image forming apparatus 200, via the Internet.

The interface section 108 is, for example, a user interface. The interface section 108 receives an operation to input data by the user of the first image forming apparatus 100, and outputs information to the user. The interface section 108 includes an input device such as a button, a keyboard, a touch panel, or a mouse, and an output device such as a display or a speaker. The interface section 108 may be configured to include the input device and the output device integrally. The interface section 108 receives an operation to input data by the user, and outputs information to the user. The interface section 108 includes the operation panel 112.

The printing section 110 has a print function for forming an image on paper, that is, a print medium. The printing section 110 includes a print engine. The print engine is a mechanical configuration that performs printing of an image to a print medium. The print engine may have, for example, a mechanism that performs printing with toner by an electrophotographic method. Alternatively, the print engine may have, for example, a mechanism that performs printing by an ink jet method. Further, the print engine may have a transport mechanism that transports a print medium.

The printing section 110 forms an image corresponding to the print data on the print medium stored in the paper feed tray 114, and transports the print medium on which the image is formed to the paper discharge tray 116. The printing section 110 performs the printing in the first order. When the first image forming apparatus 100 is the face-down machine, the printing section 110 performs the printing in the forward order for the print data. In this case, the first order is the forward order. On the other hand, when the first image forming apparatus 100 is the face-up machine, the printing section 110 performs the printing in the reverse order for the print data. In this case, the first order is the reverse order.

Further, the first image forming apparatus 100 includes a first order storage section 120, a print data acquisition section 130, and a print data accumulation section 132, as components. Further, the first image forming apparatus 100 includes a request acquisition section 140, a print job information transmission section 142, a selection result acquisition section 144, an order acquisition section 150, a change section 160, and a print data transmission section 170, as components. The first image forming apparatus 100 may have an OS as basic software. Each component described above other than the OS may operate using a function of the OS. Further, the first image forming apparatus 100 may have substantially the same components as the components of the second image forming apparatus 200 described below, as components. That is, the first image forming apparatus 100 may function as the submachine. This is the same in other embodiments described below.

Each component described above can be realized by, for example, execution of a program under the control of the processing section 102. More specifically, each component may be realized by the processing section 102 executing a program stored in the storage section 104. Further, a necessary program may be recorded on any non-volatile recording medium and installed as necessary to realize each component. These matters are the same in other embodiments.

Further, each component may be realized by any combination of hardware, firmware, and software, without being limited to being realized by software according to a program. Further, each component may be realized by using an integrated circuit, which is programmable by the user, such as an FPGA or a microcomputer. In this case, a program configured to include each component described above may be realized by using the integrated circuit. These matters are the same in other embodiments.

The first order storage section 120 stores order data indicating the first order of the first image forming apparatus 100. The first order storage section 120 may be realized by the storage section 104. When the first image forming apparatus 100 is the face-down machine, the first order storage section 120 stores data indicating that the first order is the forward order. When the first image forming apparatus 100 is the face-up machine, the first order storage section 120 stores data indicating that the first order is the reverse order.

The print data acquisition section 130 acquires the print data from the terminal device 10. Specifically, the print data acquisition section 130 acquires the print data that is a print target in the first image forming apparatus 100. The print data acquisition section 130 may acquire the print data with reception of the print data from the terminal device 10 by the communication section 106. Further, the print data acquisition section 130 may acquire the print data with acquisition of the print job from the terminal device 10. The print data acquisition section 130 acquires the print data in which the output order is the first order. Thus, when the first image forming apparatus 100 is the face-down machine, the print data acquisition section 130 acquires the print data in which the first order is the forward order. Further, when the first image forming apparatus 100 is the face-up machine, the print data acquisition section 130 acquires the print data in which the first order is the reverse order.

The print data accumulation section 132 accumulates the acquired print data. The print data accumulation section 132 may be realized by the storage section 104. The print data accumulation section 132 accumulates the print data in association with the user identification information of the user of the terminal device 10 that transmits the print data. In other words, the print data accumulation section 132 accumulates the print job including the print data and the user identification information. Accordingly, the print data accumulation section 132 stores print job information indicating a plurality of print jobs. The print job information indicates the print job list, which is a list of print jobs. The print job information may be generated for each user.

The request acquisition section 140 acquires, from the second image forming apparatus 200, a print data request for requesting transmission of the print data. In other words, the request acquisition section 140 acquires, from the second image forming apparatus 200, the request for the print data acquired by the first image forming apparatus 100. The request acquisition section 140 may acquire the print data request with reception of the print data request from the second image forming apparatus 200 by the communication section 106. Specifically, when the authentication processing is performed in the second image forming apparatus 200 and the user authentication is successful, the request acquisition section 140 acquires the print data request from the second image forming apparatus 200. The authentication processing in the second image forming apparatus 200 will be described below.

The print data request may include the user identification information, which is the identification information of the user who is successfully authenticated, and submachine identification information, which is the identification information of the second image forming apparatus 200. Further, the print data request may indicate a second order of the second image forming apparatus 200. The second order is an order in which the second image forming apparatus 200 outputs the print data (output order). When the second image forming apparatus 200 is the face-down machine, the second order is the forward order. On the other hand, when the second image forming apparatus 200 is the face-up machine, the second order is the reverse order.

With the acquisition of the print data request from the second image forming apparatus 200 by the request acquisition section 140, the second image forming apparatus 200 that requests the print data can be specified. Further, when the authentication of the user is successful in the second image forming apparatus 200, with the acquisition of the print data request from the second image forming apparatus 200 by the request acquisition section 140, the second image forming apparatus 200 that requests the print data and the user can be specified.

The print job information transmission section 142 performs processing of transmitting the print job information to the second image forming apparatus 200. The print job information transmission section 142 may control the communication section 106 to transmit the print job information to the second image forming apparatus 200. The print job information transmission section 142 transmits the print job information related to the user identification information indicated in the print data request, which is accumulated in the print data accumulation section 132, to the second image forming apparatus 200 related to the submachine identification information indicated in the print data request. That is, the print job information transmission section 142 transmits, to the second image forming apparatus 200, the print job information related to the user who is successfully authenticated.

Accordingly, the operation panel 212 of the second image forming apparatus 200 displays the print job list related to the user who is successfully authenticated. As described above, when the user operates the operation panel 212 to select the print job, the second image forming apparatus 200 transmits the selection result of the print job to the first image forming apparatus 100.

The selection result acquisition section 144 acquires the selection result of the print job from the second image forming apparatus 200. The selection result acquisition section 144 may acquire the selection result with reception of the selection result from the second image forming apparatus 200 by the communication section 106. The selection result indicates the print job selected by the user. Further, the selection result may indicate the second order of the second image forming apparatus 200. Further, the selection result may indicate a request for the print data related to the print job selected by the user. In this case, the selection result acquisition section 144 may function as a request acquisition section that acquires, from the second image forming apparatus, the request for the print data acquired by the first image forming apparatus 100.

The order acquisition section 150 acquires the second order, which is the order in which the second image forming apparatus 200 outputs the print data. The order acquisition section 150 acquires the second order of the second image forming apparatus 200 that transmits the print data request. When the second order is indicated in the print data request, the order acquisition section 150 may acquire the second order from the print data request. When the second order is indicated by the selection result, the order acquisition section 150 may acquire the second order from the selection result. Further, the order acquisition section 150 may acquire the second order from the second image forming apparatus 200, separately from the print data request and the selection result. In this case, the order acquisition section 150 may acquire the second order from the second image forming apparatus 200, in response to the acquisition of the request for the print data.

The change section 160 performs change processing of the output order in the print data. That is, the change section 160 performs the change processing of the first order in the print data. In other words, the change section 160 performs the change processing of the first order in the print data, which corresponds to the print job indicated by the selection result. The change section 160 performs the change processing on the print data stored in the print data accumulation section 132. Specifically, the change section 160 performs the change processing of the first order in the print data, based on the second order, which is the order in which the second image forming apparatus 200 outputs the print data. More specifically, the change section 160 performs the change processing of the first order of the print data, based on a result of comparison between the first order and the second order. When the first order is the same as the second order, the change section 160 does not change the first order of the print data. On the other hand, when the first order is different from the second order, the change section 160 changes the first order in the print data. That is, the change processing includes the case where the first order in the print data is changed and the case where the first order in the print data is not changed.

Examples of FIGS. 2 and 3 will be described. When the first image forming apparatus 100 is the face-down machine, the print data acquisition section 130 acquires the print data PD1 in which the first order is the forward order. When the second image forming apparatus 200 is the face-down machine, the second order is the forward order. Thus, the second order is the same as the first order. Therefore, the change section 160 does not change the print data PD1. On the other hand, when the second image forming apparatus 200 is the face-up machine, the second order is the reverse order. Thus, the second order is different from the first order. Therefore, the change section 160 changes the print data PD1, which is in the forward order, to the print data PD2, which is in the reverse order. Accordingly, the change section 160 generates the print data PD2 with the first order changed.

Further, when the first image forming apparatus 100 is the face-up machine, the print data acquisition section 130 acquires the print data PD2 in which the first order is the reverse order. When the second image forming apparatus 200 is the face-down machine, the second order is the forward order. Thus, the second order is different from the first order. Therefore, the change section 160 changes the print data PD2, which is in the reverse order, to the print data PD1, which is in the forward order. Accordingly, the change section 160 generates the print data PD1 with the first order changed. On the other hand, when the second image forming apparatus 200 is the face-up machine, the second order is the reverse order. Thus, the second order is the same as the first order. Therefore, the change section 160 does not change the print data PD2.

The print data transmission section 170 transmits, to the second image forming apparatus 200, the print data subjected to the change processing of the first order. The print data transmission section 170 may control the communication section 106 to transmit the print data to the second image forming apparatus 200. Further, the print data transmission section 170 transmits, to the second image forming apparatus 200, the print data related to the user who is successfully authenticated.

Specifically, when the first order is different from the second order, the print data transmission section 170 transmits, to the second image forming apparatus 200, the print data with the first order changed. On the other hand, when the first order is the same as the second order, the print data transmission section 170 transmits, to the second image forming apparatus 200, the print data with the first order unchanged.

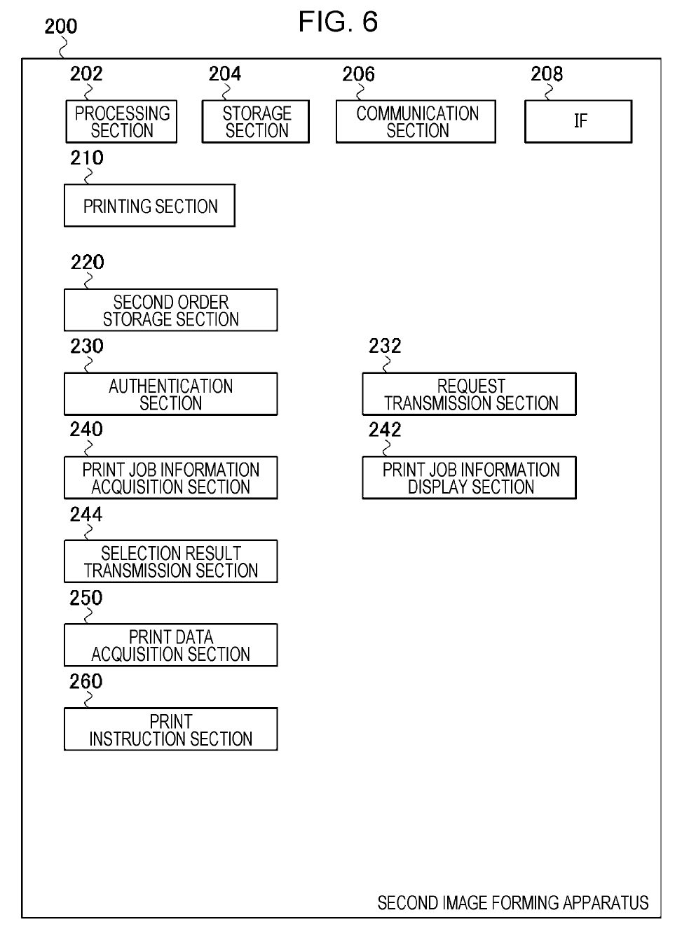

FIG. 6 is a diagram showing a configuration of the second image forming apparatus 200 according to Embodiment 1. The second image forming apparatus 200 includes a processing section 202, a storage section 204, a communication section 206, an interface section 208, and a printing section 210, as a main hardware configuration. The processing section 202, the storage section 204, the communication section 206, the interface section 208, and the printing section 210 may be coupled to each other, via a data bus or the like.

The processing section 202 is a processor such as a CPU. The processing section 202 may have a plurality of processors. The processing section 202 has a function as a calculation device that performs control processing, calculation processing, and the like. The processing section 202 controls the storage section 204, the communication section 206, the interface section 208, and the printing section 210.

The storage section 204 is a storage device such as a memory or a hard disk. The storage section 204 is, for example, a ROM or a RAM. The storage section 204 has a function of storing a control program, a calculation program, and the like, which are executed by the processing section 202. Further, the storage section 204 has a function of temporarily storing processing data and the like. The storage section 204 may include a database.

The communication section 206 performs processing necessary for the second image forming apparatus 200 to perform communication with another device, via the network 2. The communication section 206 may include a communication port, a router, a firewall, and the like. The communication section 206 performs processing for the second image forming apparatus 200 to perform communication with the terminal device 10 and the first image forming apparatus 100. The communication section 206 may perform processing for the second image forming apparatus 200 to perform communication with the terminal device 10 and the first image forming apparatus 100, via a LAN such as a wireless LAN. Further, the communication section 206 may perform processing for the second image forming apparatus 200 to perform communication with the terminal device 10 and the first image forming apparatus 100, via the Internet.

The interface section 208 is, for example, a user interface. The interface section 208 receives an operation to input data by the user of the second image forming apparatus 200, and outputs information to the user. The interface section 208 includes an input device such as a button, a keyboard, a touch panel, or a mouse, and an output device such as a display or a speaker. The interface section 208 may be configured to include the input device and the output device integrally. The interface section 208 receives an operation to input data by the user, and outputs information to the user. The interface section 208 includes the operation panel 212.

The printing section 210 has a print function for forming an image on paper, that is, a print medium. The printing section 210 includes a print engine. The print engine is a mechanical configuration that performs printing of an image to a print medium. The print engine may have, for example, a mechanism that performs printing with toner by an electrophotographic method. Alternatively, the print engine may have, for example, a mechanism that performs printing by an ink jet method. Further, the print engine may have a transport mechanism that transports a print medium.

The printing section 210 forms an image corresponding to the print data on the print medium stored in the paper feed tray 214, and transports the print medium on which the image is formed to the paper discharge tray 216. The printing section 210 performs the printing in the second order. When the second image forming apparatus 200 is the face-down machine, the printing section 210 performs the printing in the forward order for the print data. In this case, the second order is the forward order. On the other hand, when the second image forming apparatus 200 is the face-up machine, the printing section 210 performs the printing in the reverse order for the print data. In this case, the second order is the reverse order.

Further, the second image forming apparatus 200 includes a second order storage section 220, an authentication section 230, and a request transmission section 232, as components. Further, the second image forming apparatus 200 includes a print job information acquisition section 240, a print job information display section 242, a selection result transmission section 244, a print data acquisition section 250, and a print instruction section 260, as components. The second image forming apparatus 200 may have an OS as basic software. Each component described above other than the OS may operate using a function of the OS. Further, the second image forming apparatus 200 may have substantially the same components as the components of first image forming apparatus 100 described above, as components. That is, the second image forming apparatus 200 may function as the host machine. This is the same in other embodiments described below.

Each component described above can be realized by, for example, execution of a program under the control of the processing section 202. More specifically, each component can be realized by the processing section 202 executing a program stored in the storage section 204. Further, a necessary program may be recorded on any non-volatile recording medium and installed as necessary to realize each component. These matters are the same in other embodiments.

Further, each component may be realized by any combination of hardware, firmware, and software, without being limited to being realized by software according to a program. Further, each component may be realized by using an integrated circuit, which is programmable by the user, such as an FPGA or a microcomputer. In this case, a program configured to include each component described above may be realized by using the integrated circuit. These matters are the same in other embodiments.

The second order storage section 220 stores order data indicating the second order of the second image forming apparatus 200. The second order storage section 220 may be realized by the storage section 204. When the second image forming apparatus 200 is the face-down machine, the second order storage section 220 stores data indicating that the second order is the forward order. When the second image forming apparatus 200 is the face-up machine, the second order storage section 220 stores data indicating that the second order is the reverse order.

The authentication section 230 performs the authentication of the user. Specifically, the authentication section 230 determines that the user who attempts the authentication is a valid user of the second image forming apparatus 200. That is, the authentication section 230 determines whether or not the user who attempts the authentication is a user registered in advance. More specifically, the authentication section 230 acquires the identification information of the user who attempts the authentication by an operation of the interface section 208 by the user. The authentication section 230 determines whether or not the acquired identification information of the user is included in registration information registered in advance. The registration information may be stored in the second image forming apparatus 200, or may be stored in a server communicably coupled to the second image forming apparatus 200. When the registration information includes the acquired identification information of the user, the authentication section 230 determines that the authentication of the user is successful. On the other hand, when the registration information does not include the acquired identification information of the user, the authentication section 230 determines that the authentication of the user fails.

The request transmission section 232 transmits the print data request to the first image forming apparatus 100. The request transmission section 232 may control the communication section 206 to transmit the print data request to the first image forming apparatus 100. Specifically, when the user authentication is successful, the request transmission section 232 transmits, to the first image forming apparatus 100, the print data request requesting that the print data transmitted from the terminal device 10 to the first image forming apparatus 100 is transmitted to the second image forming apparatus 200. As described above, the print data request may include the user identification information, which is the identification information of the user who is successfully authenticated, and the submachine identification information, which is the identification information of the second image forming apparatus 200. Further, the print data request may indicate a second order of the second image forming apparatus 200.

The print job information acquisition section 240 acquires the print job information from the first image forming apparatus 100. The print job information acquisition section 240 may acquire the print job information with reception of the print job information from the first image forming apparatus 100 by the communication section 206. The print job information acquisition section 240 acquires, from the first image forming apparatus 100, the print job information related to the user who is successfully authenticated.

The print job information display section 242 performs processing for displaying the print job list indicated by the print job information. Specifically, the print job information display section 242 displays the print job list on the interface section 208 such as the operation panel 212. The user performs a selection operation of the print job on the print job list displayed on the interface section 208 by the print job information display section 242.

The selection result transmission section 244 transmits the selection result by the user to the first image forming apparatus 100. The selection result transmission section 244 may control the communication section 206 to transmit the selection result to the first image forming apparatus 100. As described above, the selection result indicates the print job selected by the user. Further, the selection result may indicate the second order of the second image forming apparatus 200. Further, the selection result may indicate a request for the print data related to the print job selected by the user.

The print data acquisition section 250 acquires the print data from the first image forming apparatus 100. The print data acquisition section 250 may acquire the print data with reception of the print data from the first image forming apparatus 100 by the communication section 206. When the authentication is successful, the print data acquisition section 250 acquires the print data related to the user who is successfully authenticated, from the first image forming apparatus 100 that acquires the print data from the terminal device 10. In the print data acquired by the print data acquisition section 250, the first order, which is the order in which the first image forming apparatus 100 outputs the print data, is subjected to the change processing based on the second order, which is the order in which the print data is output by the second image forming apparatus 200. In other words, in the print data acquired by the print data acquisition section 250, the first order may be changed according to the second order, which is the order in which the print data is output by the second image forming apparatus 200.

For example, when the first image forming apparatus 100 is the face-down machine and the second image forming apparatus 200 is the face-up machine, the first order of the print data is changed, from the forward order, according to the second order, which is the reverse order. On the other hand, when the first image forming apparatus 100 is the face-up machine and the second image forming apparatus 200 is the face-down machine, the first order of the print data is changed, from the reverse order, according to the second order, which is the forward order.

When the first image forming apparatus 100 is the face-down machine and the second image forming apparatus 200 is the face-down machine, the second order is the same forward order as the first order, and thus the first order of the print data is maintained as the forward order. Further, when the first image forming apparatus 100 is the face-up machine and the second image forming apparatus 200 is the face-up machine, the second order is the same reverse order as the first order, and thus the first order of the print data is maintained as the reverse order.

The print instruction section 260 instructs the printing section 210 to perform the printing of the acquired print data, and controls the printing section 210. Accordingly, the printing section 210 performs the printing of the acquired print data. As described above, in the print data that is a target of the printing performed by the printing section 210, the first order is subjected to the change processing based on the second order. Therefore, the printing section 210 performs the printing of the print data in accordance with the paper discharge function of the second image forming apparatus 200.

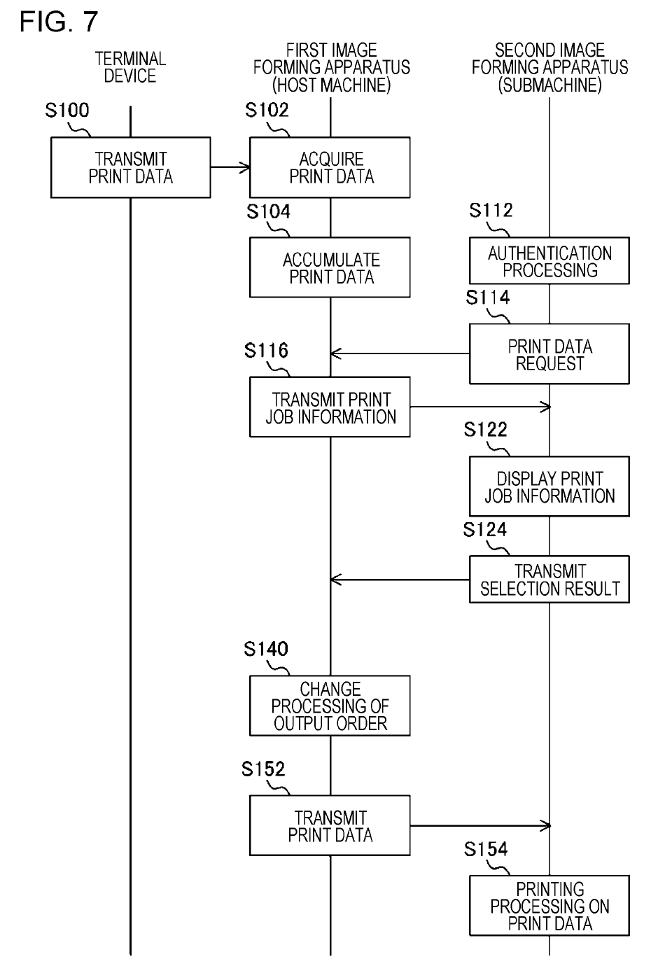

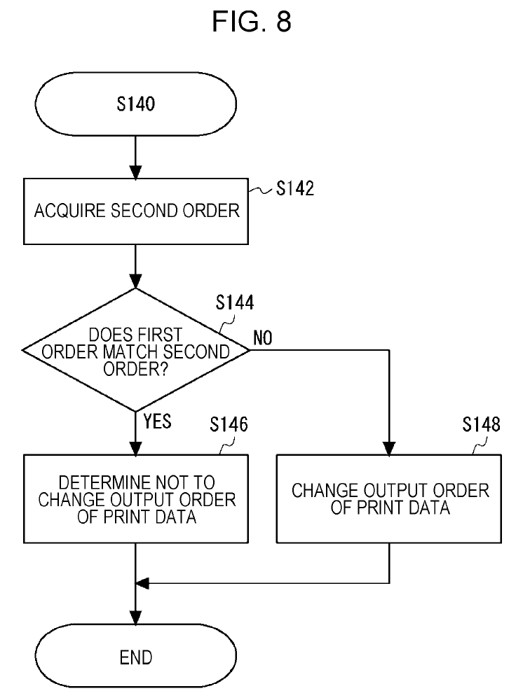

FIGS. 7 and 8 are diagrams showing the processing executed in the processing system 1 according to Embodiment 1. FIGS. 7 and 8 show a processing method executed by the first image forming apparatus 100. FIG. 7 shows a sequence diagram showing the processing method executed by the processing system 1 according to Embodiment 1.

The terminal device 10 transmits the print data to the first image forming apparatus 100 (step S100). Specifically, as described above, the print data generation section 50 generates the print data. Further, the first print data transmission section 60 transmits the generated print data to the first image forming apparatus 100. In the first image forming apparatus 100, the print data acquisition section 130 acquires the print data from the terminal device 10, as described above (step S102). The print data accumulation section 132 accumulates the acquired print data, as described above (step S104).

In the second image forming apparatus 200, the authentication section 230 performs the authentication processing for the user, as described above (step S112). When the authentication is successful, the request transmission section 232 transmits the print data request to the first image forming apparatus 100, as described above (step S114). The first image forming apparatus 100 transmits the print job information, in response to the print data request (step S116). Specifically, the request acquisition section 140 acquires the print data request from the second image forming apparatus 200, as described above. The print job information transmission section 142 performs the processing of transmitting the print job information to the second image forming apparatus 200, as described above.

The second image forming apparatus 200 displays the print job information (step S122). Specifically, the print job information acquisition section 240 acquires the print job information from the first image forming apparatus 100, as described above. Further, the print job information display section 242 causes the interface section 208 to display the print job list indicated by the print job information. In the second image forming apparatus 200, the selection result transmission section 244 transmits the selection result by the user to the first image forming apparatus 100, as described above (step S124). Accordingly, the selection result acquisition section 144 of the first image forming apparatus 100 acquires the selection result of the print job, as described above. The first image forming apparatus 100 performs the change processing of the output order in the print data (step S140).

FIG. 8 is a flowchart showing details of the processing of S140. In the first image forming apparatus 100, the order acquisition section 150 acquires the second order of the second image forming apparatus 200, as described above (step S142). The change section 160 compares the first order and the second order to determine whether or not the first order matches the second order, as described above (step S144). When the first order matches the second order (YES in S144), the change section 160 determines not to change the output order (first order) of the print data (step S146). On the other hand, when the first order does not match the second order (NO in S144), the change section 160 changes the output order (first order) of the print data, as described above (step S148). Specifically, the change section 160 changes the first order in the print data in accordance with the second order.

In the first image forming apparatus 100, the print data transmission section 170 transmits the print data after the change processing to the second image forming apparatus 200 (step S152). Accordingly, the print data acquisition section 250 of the second image forming apparatus 200 acquires the print data after the change processing. The second image forming apparatus 200 performs the printing processing on the print data (step S154). Specifically, in the second image forming apparatus 200, the print instruction section 260 instructs the printing section 210 to perform the printing of the acquired print data, as described above. Accordingly, the printing section 210 performs the printing of the acquired print data.

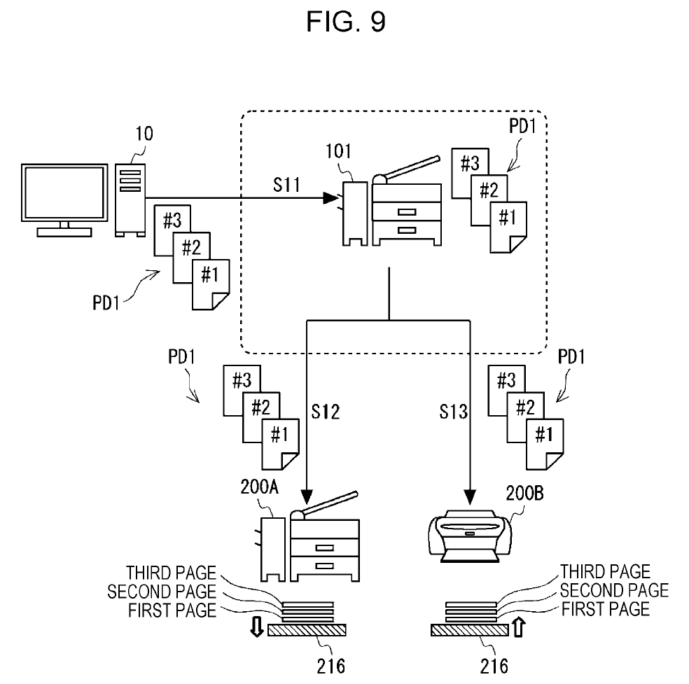

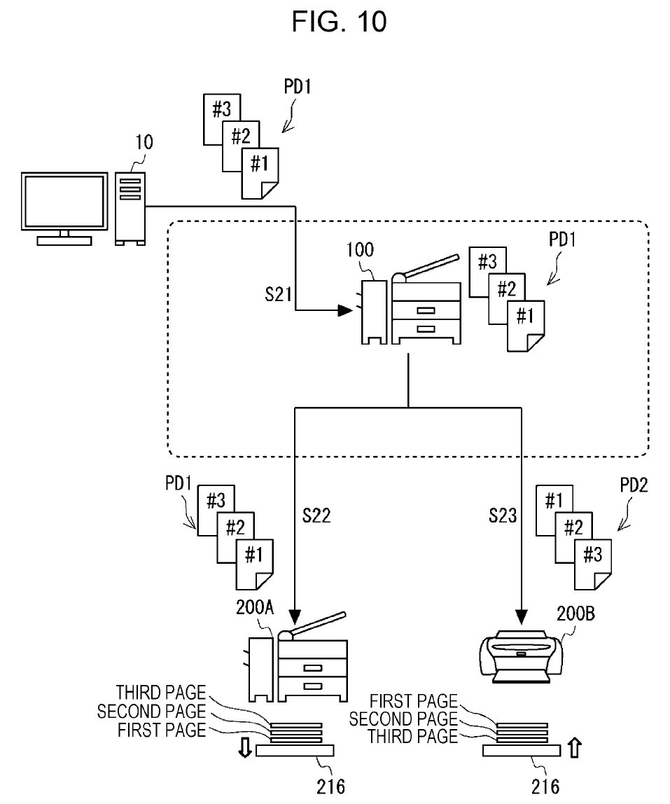

FIGS. 9 and 10 are diagrams for describing differences between a comparative example and Embodiment 1. FIG. 9 is a diagram for describing processing of a first image forming apparatus 101 according to the comparative example. In FIG. 9, the first image forming apparatus 101 is assumed to be the face-down machine. Further, a second image forming apparatus 200A is assumed to be the face-down machine. Further, a second image forming apparatus 200B is assumed to be the face-up machine.

The terminal device 10 transmits the print data PD1, which is in the forward order, to the first image forming apparatus 101, as indicated by an arrow S11. When the second image forming apparatus 200A requests the first image forming apparatus 101 for the print data, the first image forming apparatus 101 transmits the print data PD1 to the second image forming apparatus 200A, as indicated by an arrow S12. In this case, when the second image forming apparatus 200A performs the printing processing on the print data PD1, print media having lower surfaces as the printed surface are discharged to the paper discharge tray 216 in an order of a first page, a second page, and a third page. Therefore, a bundle of the print media is in a desired order. In this case, a desired print result can be obtained.

On the other hand, when the second image forming apparatus 200B requests the first image forming apparatus 101 for the print data, the first image forming apparatus 101 transmits the print data PD1 to the second image forming apparatus 200B, as indicated by an arrow S13. In this case, when the second image forming apparatus 200B performs the printing processing on the print data PD1, print media having upper surfaces as the printed surface may be discharged to the paper discharge tray 216 in an order of a first page, a second page, and a third page. In this case, a bundle of the print media is not in a desired order. Alternatively, the second image forming apparatus 200B may not be able to perform the printing by using the print data PD1. For this reason, a desired print result may not be obtained in the comparative example.

FIG. 10 is a diagram showing processing performed by the first image forming apparatus 100 according to Embodiment 1. In FIG. 10, the first image forming apparatus 100 is assumed to be the face-down machine. Further, the second image forming apparatus 200A is assumed to be the face-down machine. Further, the second image forming apparatus 200B is assumed to be the face-up machine.

The terminal device 10 transmits the print data PD1, which is in the forward order, to the first image forming apparatus 100, as indicated by an arrow S21. The second image forming apparatus 200A is assumed to request the first image forming apparatus 100 for the print data. The output order of the second image forming apparatus 200A is the same as the output order of the first image forming apparatus 100. Thus, the first image forming apparatus 100 transmits the print data PDb to the second image forming apparatus 200A without changing the output order, as indicated by an arrow S22. In this case, when the second image forming apparatus 200A performs the printing processing on the print data PD1, the print media having lower surfaces as the printed surface are discharged to the paper discharge tray 216 in the order of the first page, the second page, and the third page. Therefore, a bundle of the print media is in a desired order.

On the other hand, the second image forming apparatus 200B is assumed to request the first image forming apparatus 100 for the print data. The output order of the second image forming apparatus 200B is different from the output order of the first image forming apparatus 100. Thus, the first image forming apparatus 100 changes the output order of the print data in accordance with the output order of the second image forming apparatus 200B. That is, the first image forming apparatus 100 converts the print data PD1 into the print data PD2. As indicated by an arrow S23, the first image forming apparatus 100 transmits the print data PD2 to the second image forming apparatus 200B. In this case, when the second image forming apparatus 200B performs the printing processing on the print data PD2, print media having upper surfaces as the printed surface are discharged to the paper discharge tray 216 in an order of a third page, a second page, and a first page. Therefore, a bundle of the print media is in a desired order.

As described above, the second image forming apparatus 200 according to Embodiment 1 can acquire the print data subjected to the change processing in accordance with the second order. Therefore, in Embodiment 1, a desired print result for the user can be obtained without relying on the paper discharge functions of each of the first image forming apparatus 100 and the second image forming apparatus 200. Therefore, in Embodiment 1, convenience is improved as compared with the comparative example.

In Embodiment 1 described above, the print data request or the selection result, which is transmitted by the second image forming apparatus 200, is assumed to include the second order of the second image forming apparatus 200, but the present disclosure is not limited to such a configuration. The first image forming apparatus 100 may request the second image forming apparatus 200 to transmit the second order. On the other hand, with the inclusion of the second order in the print data request or the selection result transmitted by the second image forming apparatus 200, it is not necessary for the first image forming apparatus 100 to request the second image forming apparatus 200 to transmit the second order. Therefore, the processing of the first image forming apparatus 100 is simplified.

Further, in Embodiment 1 described above, single-sided printing is provided as an example, but the present disclosure is not limited to this configuration. That is, the same applies to a case of double-sided printing. Here, the second image forming apparatus 200B, which is the face-up machine, is assumed to request the first image forming apparatus 100, which is the face-down machine, for the print data. In Embodiment 1 described above, when the second image forming apparatus 200B performs the printing processing on the print data PD1, print media are printed on upper surfaces of odd-numbered pages in the case of double-sided printing. Thus, the print media are discharged to the paper discharge tray 216 in an order of a third page as first, a first page and a second page as second. Therefore, a bundle of the print media is in a desired order.

### Embodiment 2

Next, Embodiment 2 will be described. For clarification of the description, the following description and drawings are omitted and simplified as appropriate. Further, in each drawing, the same reference numerals are assigned to the same elements, and redundant description thereof will be omitted as necessary. Thus, in the following description, parts different from those of Embodiment 1 described above will be mainly described. In Embodiment 2, a configuration of the processing system 1 is substantially the same as that of Embodiment 1, and thus description thereof will be omitted.

Further, in Embodiment 2, a configuration of the first image forming apparatus 100 may be substantially the same as that in Embodiment 1, and thus description thereof will be omitted. The first image forming apparatus 100 according to Embodiment 2 may not include the selection result acquisition section 144, the order acquisition section 150, the change section 160, and the print data transmission section 170 shown in FIG. 5. Here, Embodiment 2 is different from Embodiment 1 in that the second image forming apparatus 200 acquires the print data from the terminal device 10. That is, the terminal device 10 transmits the print data to the second image forming apparatus 200 in Embodiment 2.

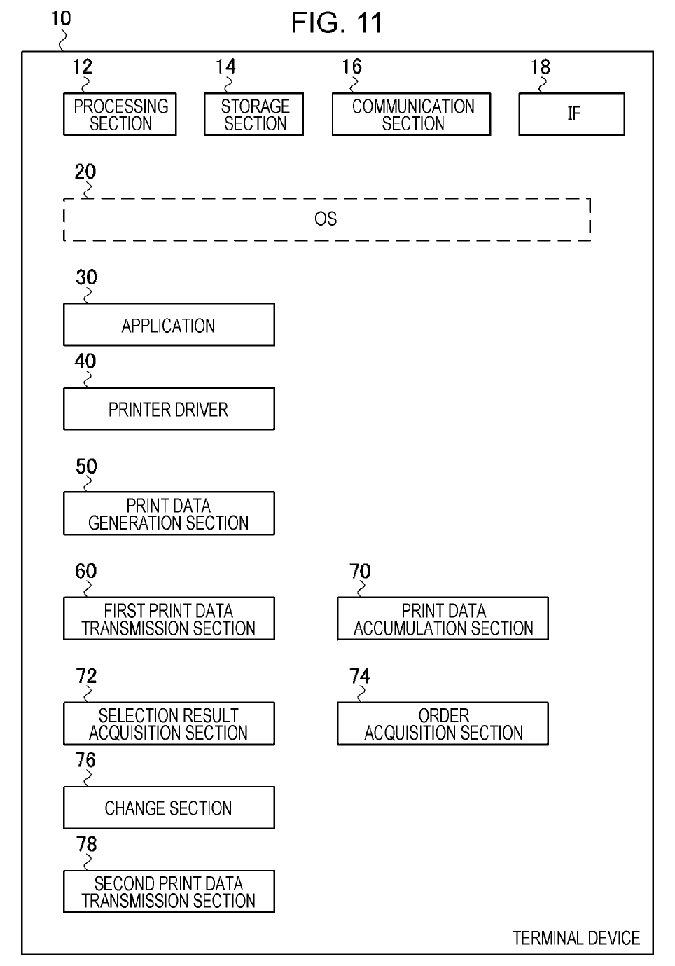

FIG. 11 is a diagram showing a configuration of the terminal device 10 according to Embodiment 2. As in the case of Embodiment 1 described above, the terminal device 10 according to Embodiment 2 has the processing section 12, the storage section 14, the communication section 16, and the interface section 18, as a main hardware configuration. Further, as in the case of Embodiment 1 described above, the terminal device 10 according to Embodiment 2 includes the OS 20, the application 30, the printer driver 40, the print data generation section 50, and the first print data transmission section 60, as components. Further, the terminal device 10 according to Embodiment 2 further includes a print data accumulation section 70, a selection result acquisition section 72, an order acquisition section 74, a change section 76, and a second print data transmission section 78. The OS 20, the application 30, the printer driver 40, the print data generation section 50, and the first print data transmission section 60 are substantially the same as those in Embodiment 1, and thus description thereof will be omitted.

The print data accumulation section 70 accumulates the print data transmitted by the first print data transmission section 60 to the first image forming apparatus 100. The print data accumulation section 70 may be realized by the storage section 14. Further, the print data accumulation section 70 may be realized by a spooler.

The selection result acquisition section 72 may have substantially the same function as the selection result acquisition section 144 described above. The selection result acquisition section 72 acquires the selection result of the print job from the second image forming apparatus 200. The selection result acquisition section 72 may acquire the selection result with reception of the selection result from the second image forming apparatus 200 by the communication section 16. The selection result may indicate the second order of the second image forming apparatus 200. Further, the selection result may indicate the print data request for the print job selected by the user. In this case, the selection result acquisition section 72 may function as a request acquisition section that acquires, from the second image forming apparatus, the print data request acquired by the first image forming apparatus 100.

The order acquisition section 74 may have substantially the same function as the order acquisition section 150 described above. The order acquisition section 74 acquires the second order, which is the order in which the second image forming apparatus 200 outputs the print data. When the second order is indicated by the selection result, the order acquisition section 74 may acquire the second order from the selection result. When the second order is indicated in the print data request, the order acquisition section 74 may acquire the second order from the print data request. Further, the order acquisition section 74 may acquire the second order from the second image forming apparatus 200, separately from the selection result. Further, the order acquisition section 74 may acquire the second order, in response to the acquisition of the selection result.

The change section 76 may have substantially the same function as the change section 160 described above. The change section 76 performs the change processing of the output order in the print data. That is, the change section 76 performs the change processing of the first order in the print data. In other words, the change section 76 performs the change processing of the first order in the print data, which corresponds to the print job indicated by the selection result. The change section 76 performs the change processing on the print data stored in the print data accumulation section 70. Specifically, the change section 76 performs the change processing of the first order in the print data, based on the second order. More specifically, the change section 76 performs the change processing of the first order of the print data, based on a result of comparison between the first order and the second order. When the first order is the same as the second order, the change section 76 does not change the first order of the print data. On the other hand, when the first order is different from the second order, the change section 76 changes the first order in the print data.

The second print data transmission section 78 may have substantially the same function as the print data transmission section 170 described above. The second print data transmission section 78 may control the communication section 16 to transmit the print data to the second image forming apparatus 200. When the first order is different from the second order, the second print data transmission section 78 transmits, to the second image forming apparatus 200, the print data with the first order changed. When the first order is the same as the second order, the second print data transmission section 78 transmits, to the second image forming apparatus 200, the print data with the first order unchanged.

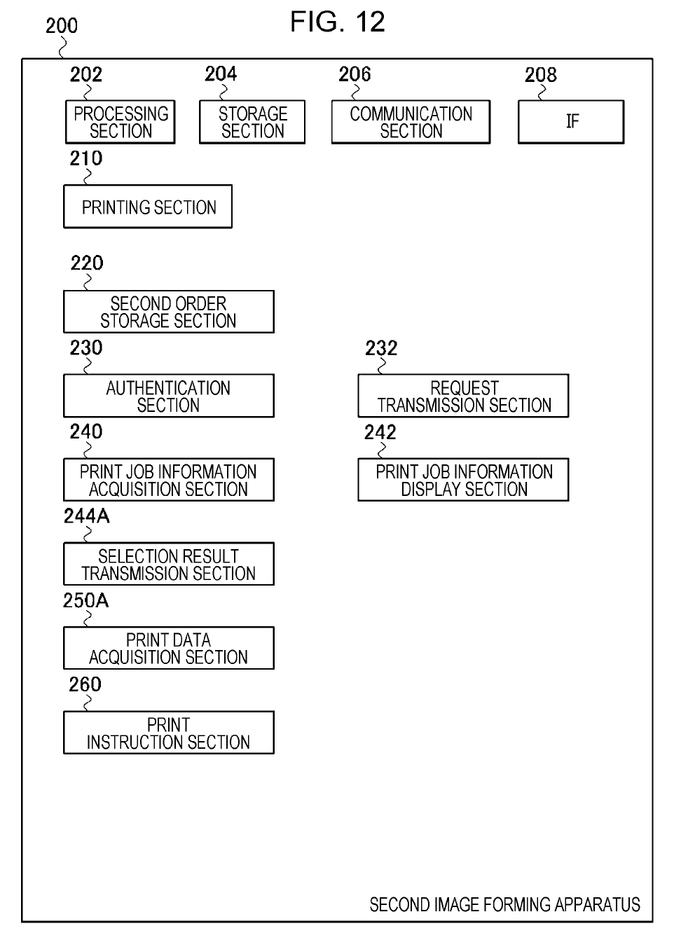

FIG. 12 is a diagram showing a configuration of the second image forming apparatus 200 according to Embodiment 2. As in the case of Embodiment 1 described above, the second image forming apparatus 200 according to Embodiment 2 has the processing section 202, the storage section 204, the communication section 206, the interface section 208, and the printing section 210, as a main hardware configuration. Further, as in the case of Embodiment 1 described above, the second image forming apparatus 200 according to Embodiment 2 includes the second order storage section 220, the authentication section 230, the request transmission section 232, the print job information acquisition section 240, the print job information display section 242, and the print instruction section 260, as components. Further, the second image forming apparatus 200 according to Embodiment 2 includes a selection result transmission section 244A and a print data acquisition section 250A, instead of the selection result transmission section 244 and the print data acquisition section 250. Among the components of the second image forming apparatus 200 according to Embodiment 2, the components other than the selection result transmission section 244A and the print data acquisition section 250A are substantially the same as those of Embodiment 1, and thus description thereof will be omitted.

The selection result transmission section 244A transmits the selection result by the user to the terminal device 10. The selection result transmission section 244A may control the communication section 206 to transmit the selection result to the terminal device 10. Since other functions of the selection result transmission section 244A are substantially the same as functions of the selection result transmission section 244, description thereof will be omitted.

The print data acquisition section 250A acquires print data from the terminal device 10. The print data acquisition section 250A may acquire the print data with reception of the print data from the terminal device 10 by the communication section 206. When the authentication is successful, the print data acquisition section 250A acquires, from the terminal device 10, the print data related to the user who is successfully authenticated. In the print data acquired by the print data acquisition section 250A, the first order, which is the order in which the first image forming apparatus 100 outputs the print data, is subjected to the change processing based on the second order, which is the order in which the print data is output by the second image forming apparatus 200.

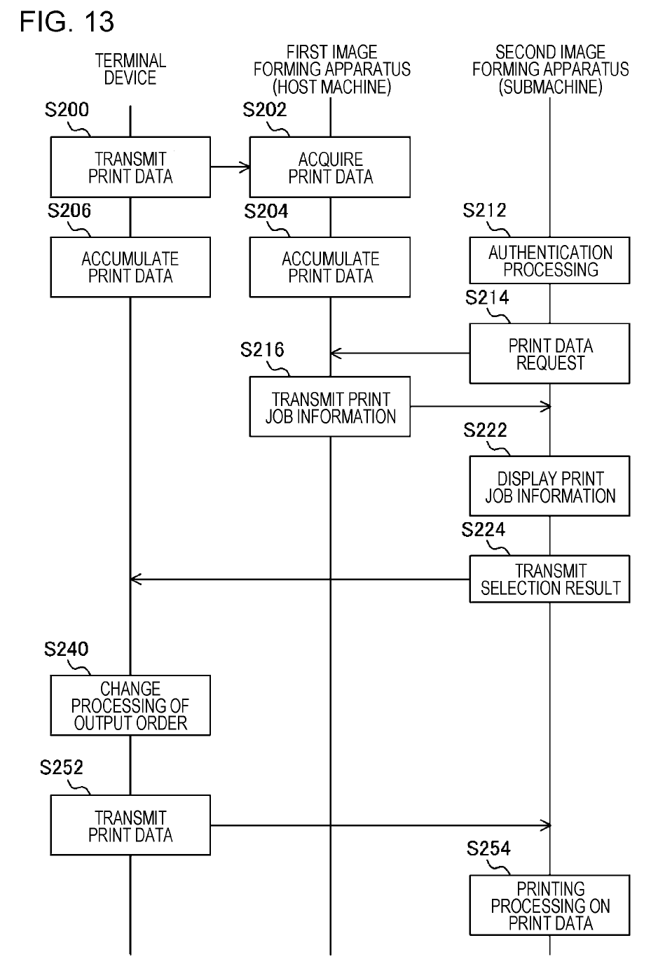

FIG. 13 is a diagram showing the processing executed in the processing system 1 according to Embodiment 2. FIG. 13 shows a processing method executed by the second image forming apparatus 200. FIG. 13 is a sequence diagram showing the processing method executed by the processing system 1 according to Embodiment 2.

As in the processing of S100 shown in FIG. 7 described above, the terminal device 10 transmits the print data to the first image forming apparatus 100 (step S200). Further, as in the processing of S102 shown in FIG. 7 described above, in the first image forming apparatus 100, the print data acquisition section 130 acquires the print data from the terminal device 10 (step S202). The print data accumulation section 132 accumulates the acquired print data (step S204). Further, in the terminal device 10, the print data accumulation section 70 accumulates the print data transmitted to the first image forming apparatus 100, as described above (step S206).

As in the processing of S112 shown in FIG. 7 described above, in the second image forming apparatus 200, the authentication section 230 performs the authentication processing for the user (step S212). When the authentication is successful, the request transmission section 232 transmits the print data request to the first image forming apparatus 100 (step S214). As in the processing of S116 shown in FIG. 7 described above, the first image forming apparatus 100 transmits the print job information, in response to the print data request (step S216).

As in the processing of S122 shown in FIG. 7 described above, the second image forming apparatus 200 displays the print job information (step S222). In the second image forming apparatus 200, the selection result transmission section 244A transmits the selection result by the user to the terminal device 10, as described above (step S224). Accordingly, the selection result acquisition section 72 of the terminal device 10 acquires the selection result of the print job, as described above. The terminal device 10 performs the change processing of the output order in the print data in substantially the same manner as the processing shown in FIG. 8 (step S240).

Specifically, as in the processing of S142 shown in FIG. 8 described above, the order acquisition section 74 acquires the second order of the second image forming apparatus 200. As in the processing of S144 shown in FIG. 8 described above, the change section 76 compares the first order and the second order to determine whether or not the first order matches the second order. When the first order matches the second order, the change section 76 determines not to change the output order (first order) of the print data, as in the processing of S146 shown in FIG. 8 described above. On the other hand, when the first order does not match the second order, the change section 76 changes the output order (first order) of the print data, as in the processing of S148 shown in FIG. 8 described above. Specifically, the change section 76 changes the first order in the print data in accordance with the second order.

In the terminal device 10, the second print data transmission section 78 transmits, to the second image forming apparatus 200, the print data after the change processing (step S252). Accordingly, the print data acquisition section 250A of the second image forming apparatus 200 acquires the print data after the change processing. As in the processing of S154 shown in FIG. 7 described above, the second image forming apparatus 200 performs the printing processing on the print data (step S254).

As in the case of Embodiment 1, the second image forming apparatus 200 according to Embodiment 2 can acquire the print data subjected to the change processing in accordance with the second order. Therefore, in Embodiment 2, as in Embodiment 1, a desired print result for the user can be obtained without relying on the paper discharge functions of each of the first image forming apparatus 100 and the second image forming apparatus 200. Therefore, in Embodiment 2, convenience is improved as in the case of Embodiment 1.

In Embodiment 2 described above, the selection result transmitted by the second image forming apparatus 200 is assumed to include the second order of the second image forming apparatus 200, but the present disclosure is not limited to such a configuration. The terminal device 10 may request the second image forming apparatus 200 to transmit the second order. On the other hand, with the inclusion of the second order in the selection result transmitted by the second image forming apparatus 200, it is not necessary for the terminal device 10 to request the second image forming apparatus 200 to transmit the second order. Therefore, the processing of the terminal device 10 is simplified.

### Embodiment 3

Next, Embodiment 3 will be described. For clarification of the description, the following description and drawings are omitted and simplified as appropriate. Further, in each drawing, the same reference numerals are assigned to the same elements, and redundant description thereof will be omitted as necessary. Thus, in the following description, parts different from those of Embodiment 1 described above will be mainly described. In Embodiment 3, a configuration of the processing system 1 is substantially the same as that of Embodiment 1, and thus description thereof will be omitted.

Further, in Embodiment 3, configurations of the terminal device 10 and the second image forming apparatus 200 may be substantially the same as those in Embodiment 1, respectively, and thus description thereof will be omitted. Embodiment 3 is different from Embodiment 1 in that the first image forming apparatus 100 determines the second order. That is, in Embodiment 3, the first image forming apparatus 100 determines whether the second image forming apparatus 200 is the face-down machine or the face-up machine. Thus, in Embodiment 3, the print data request and the selection result may not indicate the second order. Further, in Embodiment 3, the first image forming apparatus 100 may not request the second order from the second image forming apparatus 200.

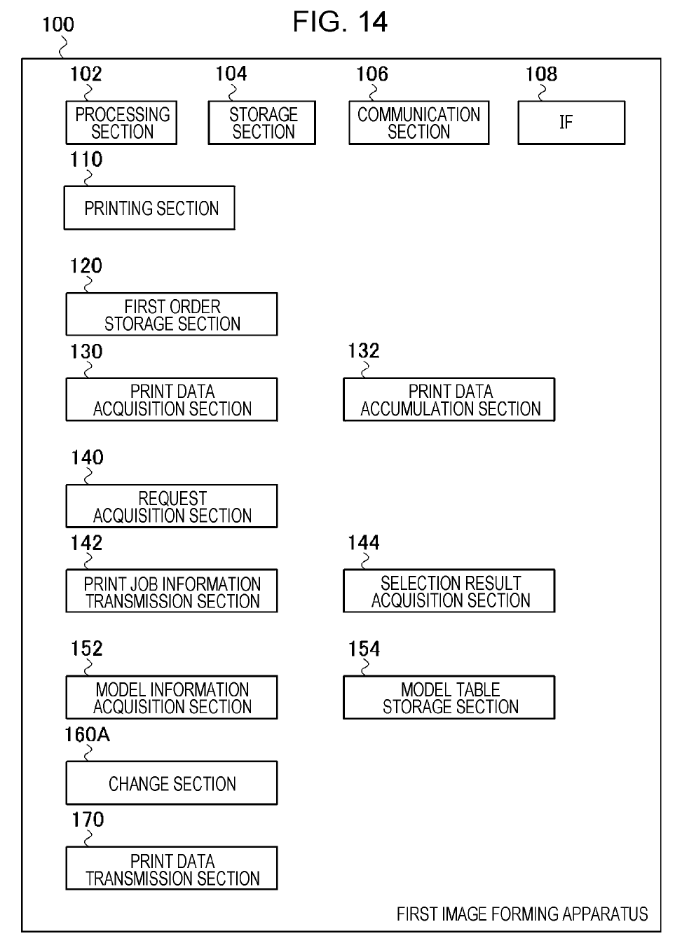

FIG. 14 is a diagram showing a configuration of the first image forming apparatus 100 according to Embodiment 3. As in the case of Embodiment 1 described above, the first image forming apparatus 100 according to Embodiment 3 has the processing section 102, the storage section 104, the communication section 106, the interface section 108, and the printing section 110, as a main hardware configuration. Further, as in the case of Embodiment 1 described above, the first image forming apparatus 100 according to Embodiment 3 has the first order storage section 120, the print data acquisition section 130, and the print data accumulation section 132, as components. Further, the first image forming apparatus 100 according to Embodiment 3 includes the request acquisition section 140, the print job information transmission section 142, the selection result acquisition section 144, and the print data transmission section 170, as components. Further, the first image forming apparatus 100 according to Embodiment 3 includes a model information acquisition section 152, a model table storage section 154, and a change section 160A, instead of the order acquisition section 150 and the change section 160. Among the components of the first image forming apparatus 100 according to Embodiment 3, the components other than the model information acquisition section 152, the model table storage section 154, and the change section 160A are substantially the same as those of Embodiment 1, and thus description thereof will be omitted. In Embodiment 3, at least one of the print data request and the selection result acquired from the second image forming apparatus 200 by the first image forming apparatus 100 may indicate model information of the second image forming apparatus 200.

The model information acquisition section 152 acquires the model information of the second image forming apparatus 200 that transmits the print data request. The model information indicates a model of the second image forming apparatus 200. The model information may indicate, for example, a model number and a manufacturer name of the second image forming apparatus 200. When the model information is indicated in the print data request, the model information acquisition section 152 may acquire the model information from the print data request. When the model information is indicated by the selection result, the model information acquisition section 152 may acquire the model information from the selection result. Further, the model information acquisition section 152 may acquire the model information from the second image forming apparatus 200, separately from the print data request and the selection result. In this case, the model information acquisition section 152 may acquire the model information from the second image forming apparatus 200, in response to the acquisition of the request for the print data.

The model table storage section 154 stores a model table. The model table storage section 154 may be realized by the storage section 104. The model table indicates whether the model is the face-down machine or the face-up machine for each model. That is, the model table associates the model with the paper discharge function of the model. The model table storage section 154 may be provided in a device such as a server that is communicably coupled to the first image forming apparatus 100.

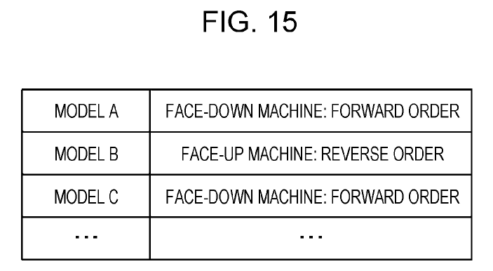

FIG. 15 is a diagram illustrating a model table according to Embodiment 3. In the example of FIG. 15, the model table indicates that a model A is the face-down machine. Further, the model table indicates that a model B is the face-up machine. Further, the model table indicates that a model C is the face-down machine. Therefore, the second order of the second image forming apparatus 200, which is the model A, is the forward order. The second order of the second image forming apparatus 200, which is the model B, is the reverse order. The second order of the second image forming apparatus 200, which is the model C, is the forward order.

The change section 160A performs the change processing of the first order of the print data, based on the model information. That is, the change section 160A performs the change processing of the first order in the print data, which corresponds to the print job indicated by the selection result, based on the model information of the second image forming apparatus 200 that transmits the print data request. The change section 160A performs the change processing of the first order on the print data stored in the print data accumulation section 132, using the model information and the model table.

Specifically, the change section 160A determines the second order of the second image forming apparatus 200, using the model information acquired from the second image forming apparatus 200 and the model table. For example, in the example of FIG. 15, when the model information is indicated as "model A", the change section 160A determines the second order of the second image forming apparatus 200 as "forward order". Further, when the model information is indicated as "model B", the change section 160A determines the second order of the second image forming apparatus 200 as "reverse order". Further, when the model information is indicated as "model C", the change section 160A determines the second order of the second image forming apparatus 200 as "forward order". The change section 160A performs the change processing of the first order in the print data, based on the determined second order. More specifically, the change section 160A performs the change processing of the first order of the print data, based on a result of comparison between the first order and the second order. When the first order is the same as the second order, the change section 160A does not change the first order of the print data. On the other hand, when the first order is different from the second order, the change section 160A changes the first order in the print data.

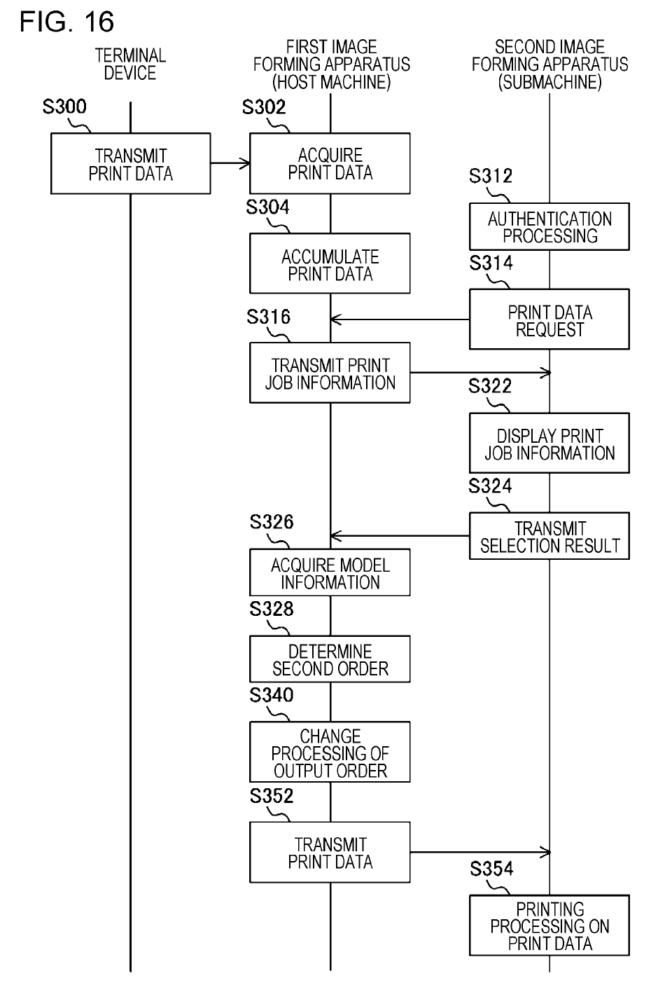

FIG. 16 is a diagram showing the processing executed by the processing system 1 according to Embodiment 3. FIG. 16 shows a processing method executed by the first image forming apparatus 100. FIG. 16 is a sequence diagram showing the processing method executed by the processing system 1 according to Embodiment 3.

As in the processing of S100 shown in FIG. 7 described above, the terminal device 10 transmits the print data to the first image forming apparatus 100 (step S300). As in the processing of S102 shown in FIG. 7 described above, in the first image forming apparatus 100, the print data acquisition section 130 acquires the print data from the terminal device 10 (step S302). The print data accumulation section 132 accumulates the acquired print data (step S304).

As in the processing of S112 shown in FIG. 7 described above, in the second image forming apparatus 200, the authentication section 230 performs the authentication processing for the user (step S312). When the authentication is successful, the request transmission section 232 transmits the print data request to the first image forming apparatus 100 (step S314). As in the processing of S116 shown in FIG. 7 described above, the first image forming apparatus 100 transmits the print job information, in response to the print data request (step S316).

As in the processing of S122 shown in FIG. 7 described above, the second image forming apparatus 200 displays the print job information (step S322). As in the processing of S124 shown in FIG. 7 described above, in the second image forming apparatus 200, the selection result transmission section 244 transmits the selection result to the first image forming apparatus 100 (step S324). Accordingly, the selection result acquisition section 144 of the first image forming apparatus 100 acquires the selection result of the print job, as described above.

In the first image forming apparatus 100, the model information acquisition section 152 acquires the model information as described above (step S326). As described above, the change section 160A determines the second order of the second image forming apparatus 200 based on the model information (step S328). The change section 160A performs the change processing of the output order in the print data (step S340). The change section 160A performs processing other than the processing of S142 in the flowchart shown in FIG. 8. Therefore, the processing of S142 is unnecessary in Embodiment 3.

As in the processing of S152 shown in FIG. 7 described above, in the first image forming apparatus 100, the print data transmission section 170 transmits the print data after the change processing to the second image forming apparatus 200 (step S352). Accordingly, the print data acquisition section 250 of the second image forming apparatus 200 acquires the print data after the change processing. As in the processing of S154 shown in FIG. 7 described above, the second image forming apparatus 200 performs the printing processing on the print data (step S354).

As in the case of Embodiment 1, the second image forming apparatus 200 according to Embodiment 3 can acquire the print data subjected to the change processing in accordance with the second order. Therefore, in Embodiment 3, as in Embodiment 1, a desired print result for the user can be obtained without relying on the paper discharge functions of each of the first image forming apparatus 100 and the second image forming apparatus 200. Therefore, in Embodiment 3, convenience is improved as in the case of Embodiment 1. Further, in Embodiment 3, a desired print result for the user can be obtained with the print data request and the selection result not indicating the second order.

### First Modification Example of Embodiment 3

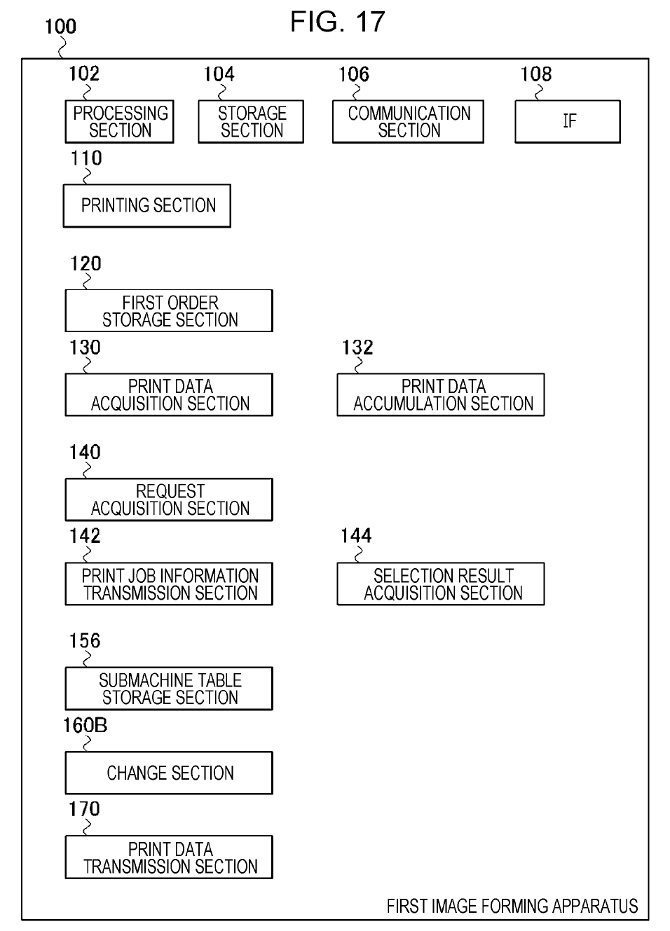

FIG. 17 is a diagram showing a configuration of the first image forming apparatus 100 according to a first modification example of Embodiment 3. The first image forming apparatus 100 according to the first modification example includes a submachine table storage section 156 and a change section 160B, instead of the model information acquisition section 152, the model table storage section 154, and the change section 160A. Among the components of the first image forming apparatus 100 according to the first modification example, the components other than the submachine table storage section 156 and the change section 160B are substantially the same as those of Embodiment 3 described above, and thus description thereof will be omitted. In the first modification example, the print data request and the selection result may not indicate the model information of the second image forming apparatus 200. As described above, at least one of the print data request and the selection result indicates the submachine identification information, which is the identification information of the second image forming apparatus 200 that transmits the print data request.

The submachine table storage section 156 stores a submachine table. The submachine table storage section 156 may be realized by the storage section 104. The submachine table indicates, for each submachine, that is, each second image forming apparatus 200, whether the second image forming apparatus 200 is the face-down machine or the face-up machine. The submachine table associates the submachine identification information of each of the second image forming apparatuses 200 with the paper discharge function of the second image forming apparatus 200. In other words, the submachine table indicates the second order of each of the second image forming apparatuses 200. That is, the submachine table storage section 156 stores the second order of the second image forming apparatus 200. In other words, the first image forming apparatus 100 stores the second order of the second image forming apparatus 200. The submachine table may be stored in the first image forming apparatus 100 when an initial communication setting is performed between the first image forming apparatus 100 and the second image forming apparatus 200. Further, the submachine table storage section 156 may be provided in a device such as a server that is communicably coupled to the first image forming apparatus 100.

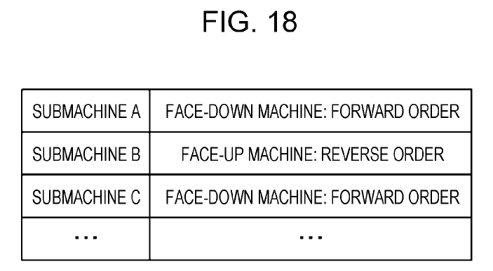

FIG. 18 is a diagram illustrating a submachine table according to the first modification example of Embodiment 3. In the example of FIG. 18, the submachine table indicates that a submachine A is the face-down machine. Further, the submachine table indicates that a submachine B is the face-up machine. Further, the submachine table indicates that a submachine C is the face-down machine. Therefore, the second order of the second image forming apparatus 200, which is the submachine A, is the forward order. The second order of the second image forming apparatus 200, which is the submachine B, is the reverse order. The second order of the second image forming apparatus 200, which is the submachine C, is the forward order.

The change section 160B performs the change processing of the first order of the print data, based on the second order stored in the first image forming apparatus 100. The change section 160B performs the change processing of the first order in the print data, which corresponds to the print job indicated by the selection result, based on the submachine identification information of the second image forming apparatus 200 that transmits the print data request. The change section 160B performs the change processing of the first order on the print data stored in the print data accumulation section 132, using the submachine identification information of the second image forming apparatus 200 and the submachine table stored in the first image forming apparatus 100.

Specifically, the change section 160B determines the second order of the second image forming apparatus 200, using the submachine identification information of the second image forming apparatus 200 and the submachine table. For example, in the example of FIG. 18, when the submachine identification information is indicated as "submachine A", the change section 160B determines the second order of the second image forming apparatus 200 as "forward order". Further, when the submachine identification information is indicated as "submachine B", the change section 160B determines the second order of the second image forming apparatus 200 as "reverse order". Further, when the submachine identification information is indicated as "submachine C", the change section 160B determines the second order of the second image forming apparatus 200 as "forward order". The change section 160B changes the first order in the print data, based on the determined second order. More specifically, the change section 160B changes the first order of the print data, based on a result of comparison between the first order and the second order. When the first order is the same as the second order, the change section 160B does not change the first order of the print data. On the other hand, when the first order is different from the second order, the change section 160B changes the first order in the print data.

As described above, in the first modification example of Embodiment 3, the change section 160B is configured to perform the change processing of the first order of the print data, based on the second order of the second image forming apparatus 200 stored in the first image forming apparatus 100. Accordingly, the first image forming apparatus 100 does not need to acquire the second order from the second image forming apparatus 200 each time the print data request is acquired.

### Second Modification Example of Embodiment 3

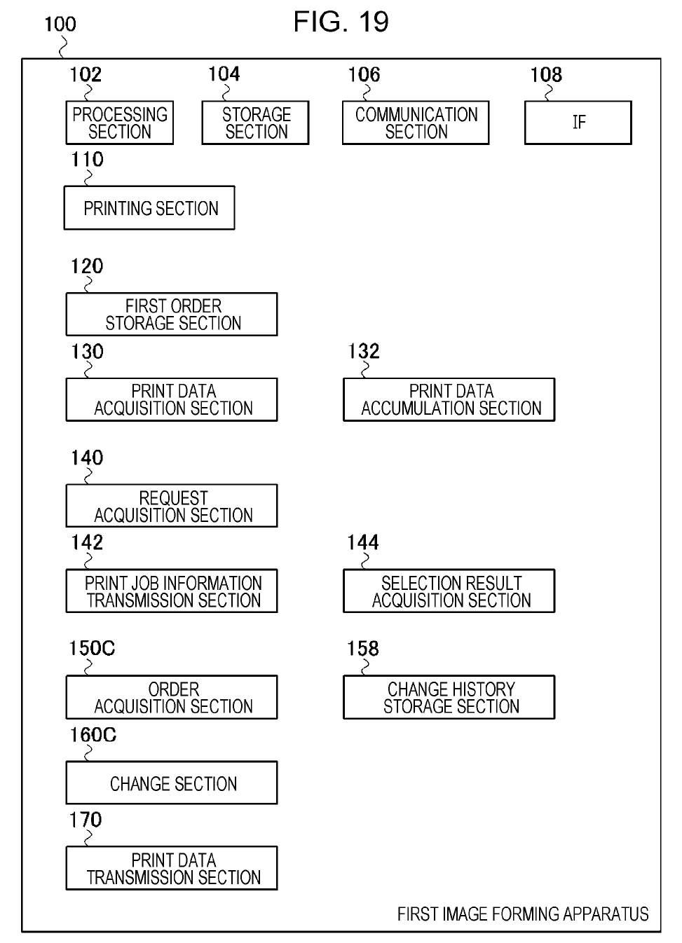

FIG. 19 is a diagram showing a configuration of the first image forming apparatus 100 according to a second modification example of Embodiment 3. The first image forming apparatus 100 according to the second modification example includes an order acquisition section 150C, a change history storage section 158, and a change section 160C, instead of the model information acquisition section 152, the model table storage section 154, and the change section 160A. Among the components of the first image forming apparatus 100 according to the second modification example, the components other than the order acquisition section 150C, the change history storage section 158, and the change section 160C are substantially the same as those of Embodiment 3 described above, and thus description thereof will be omitted. In the second modification example, the print data request and the selection result may not indicate the model information of the second image forming apparatus 200. As described above, at least one of the print data request and the selection result indicates the identification information of the second image forming apparatus 200 that transmits the print data request.

The order acquisition section 150C has substantially the same function as the order acquisition section 150 described above. However, it should be noted that the order acquisition section 150C does not acquire the second order again from the second image forming apparatus 200 from which the second order is acquired once.

The change history storage section 158 stores a change history. The change history storage section 158 may be realized by the storage section 104. The change history is a history of the change processing of the first order of the print data, for each submachine, that is, each second image forming apparatus 200.

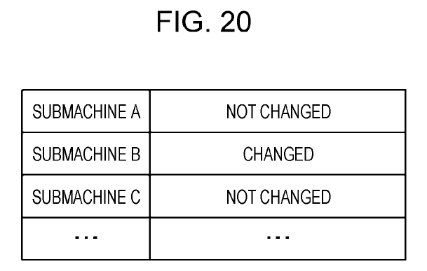

FIG. 20 is a diagram illustrating a change history according to the second modification example of Embodiment 3. In the example of FIG. 20, the change history indicates that the first order of the print data is not changed in the change processing for the submachine A. Further, the change history indicates that the first order of the print data is changed in the change processing for the submachine B. Further, the change history indicates that the first order of the print data is not changed in the change processing for the submachine C.

In first change processing for a certain second image forming apparatus 200, the change section 160C performs substantially the same processing as the change section 160 according to Embodiment 1. That is, the change section 160C performs the change processing of the first order of the print data, based on comparison between the second order acquired by the order acquisition section 150C and the first order of the first image forming apparatus 100. The change section 160C stores the history of the change processing in the change history storage section 158.

On the other hand, in second and subsequent change processing for the second image forming apparatus 200, the change section 160C performs the change processing of the first order of the print data by using the change history stored in the change history storage section 158. For example, in the example of FIG. 20, when the second image forming apparatus 200 that transmits the print data request is the submachine A, the change section 160C determines, with reference to the change history, that the first order of the print data is not changed. On the other hand, when the second image forming apparatus 200 that transmits the print data request is the submachine B, the change section 160C changes, with reference to the change history, the first order of the print data.

As described above, in the second modification example of Embodiment 3, the change section 160C is configured to change the first order of the print data, based on the history of the change processing of the first order of the print data stored in the first image forming apparatus 100. Accordingly, the first image forming apparatus 100 does not need to acquire the second order from the second image forming apparatus 200 each time the print data request is acquired.

### Modification Example

The present disclosure is not limited to the above embodiments, and can be changed as appropriate within a range without departing from the gist. For example, the order of each piece of processing in the sequence diagram and flowchart described above can be changed as appropriate. Further, one or more pieces of processing in the sequence diagram and flowchart described above may be omitted. Further, the plurality of embodiments described above can be applied to each other. For example, Embodiment 3 can be applied not only to Embodiment 1 but also to Embodiment 2.

Further, in the embodiments described above, the first image forming apparatus 100 transmits the print job information to the second image forming apparatus 200 that transmits the print data request, but the present disclosure is not limited to such a configuration. That is, the first image forming apparatus 100 may not transmit the print job information to the second image forming apparatus 200. For example, the first image forming apparatus 100 may perform the change processing on all of the print data related to the user indicated in the print data request, which is accumulated in the print data accumulation section 132. The first image forming apparatus 100 may transmit, to the second image forming apparatus 200, all of the print data subjected to the change processing. Further, for example, the first image forming apparatus 100 may perform the change processing on the latest print data related to the user indicated in the print data request, which is accumulated in the print data accumulation section 132.

In the examples described above, the program includes a group of commands (or software codes) for causing a computer to perform one or more functions described in the embodiment when being read by the computer. The program may be stored in a non-transitory computer-readable medium or a physical storage medium. By way of non-limiting example, the computer-readable medium or the physical storage medium includes a random-access memory (RAM), a read-only memory (ROM), a flash memory, a solid-state drive (SSD), or another memory technology, a CD-ROM, a digital versatile disk (DVD), a Blu-ray (registered trademark) disk, or another optical disk storage, and a magnetic cassette, a magnetic tape, a magnetic disk storage, or another magnetic storage device. The program may be transmitted on a transitory computer-readable medium or a communication medium. By way of non-limiting example, the transitory computer-readable medium or the communication medium includes a propagating signal in an electrical, optical, acoustic, or another form. Further, the program is included in a program product.

What is claimed is:

1. A first image forming apparatus comprising:
a print data acquisition section that acquires print data from a terminal device;
a change section that performs change processing of a first order, which is an order in which the first image forming apparatus outputs the print data, in the print data; and
a print data transmission section that transmits, to a second image forming apparatus, the print data subjected to the change processing of the first order.

2. The first image forming apparatus according to claim 1, further comprising:
an order acquisition section that acquires a second order, which is an order in which the second image forming apparatus outputs the print data, wherein
the change section performs the change processing of the first order of the print data, based on the second order.

3. The first image forming apparatus according to claim 2, wherein
the change section performs the change processing of the first order of the print data, based on a result of comparison between the first order and the second order.

4. The first image forming apparatus according to claim 3, wherein
the change section changes the first order of the print data when the first order is different from the second order.

5. The first image forming apparatus according to claim 2, further comprising:
a request acquisition section that acquires, from the second image forming apparatus, a request for the print data acquired by the first image forming apparatus, wherein
the order acquisition section acquires the second order, in response to the acquisition of the request.

6. The first image forming apparatus according to claim 5, wherein
the request acquisition section acquires the request from the second image forming apparatus when authentication of a user is successful in the second image forming apparatus.

7. The first image forming apparatus according to claim 6, wherein
the print data transmission section transmits, to the second image forming apparatus, print data related to the user who is successfully authenticated.

8. The first image forming apparatus according to claim 1, further comprising:
a model information acquisition section that acquires model information of the second image forming apparatus, wherein
the change section performs the change processing of the first order of the print data, based on the model information.

9. The first image forming apparatus according to claim 1, wherein
the change section performs the change processing of the first order of the print data, based on a second order stored in the first image forming apparatus, the second order being an order in which the second image forming apparatus outputs the print data.

10. The first image forming apparatus according to claim 1, wherein
the change section performs the change processing of the first order of the print data, based on a history of the change processing of the first order of the print data.

11. A second image forming apparatus comprising:
an authentication section that executes authentication of a user;
a print data acquisition section that acquires, when the authentication is successful, print data from a first image forming apparatus that acquires the print data from a terminal device or from the terminal device that transmits the print data to the first image forming apparatus; and
a printing section that performs printing of the acquired print data, wherein
a first order, which is an order in which the first image forming apparatus outputs the print data, in the print data acquired by the print data acquisition section is subjected to change processing based on an order in which the print data is output by the second image forming apparatus.

12. A processing method executed by a first image forming apparatus, the processing method comprising:
acquiring print data from a terminal device;
performing change processing of a first order, which is an order in which the first image forming apparatus outputs the print data, in the print data; and
transmitting, to a second image forming apparatus, the print data subjected to the change processing of the first order.
